(19) United States
(12) Patent Application Publication
(10) Pub. No.: US 2025/0293267 A1
(43) Pub. Date: Sep. 18, 2025

(54) ELECTROCHEMICAL CELL

(71) Applicant: Denso Corporation, Kariya-city (JP)

(72) Inventors: Keita TAKAHASHI, Kariya-city (JP); Keisuke Kobayashi, Kariya-city (JP); Naohiro Hayashi, Kariya-city (JP); Takuma Hitomi, Kariya-city (JP); Atsuhiro Sumiya, Kariya-city (JP)

(73) Assignee: Denso Corporation, Kariya-city (JP)

(21) Appl. No.: 19/079,046

(22) Filed: Mar. 13, 2025

(30) Foreign Application Priority Data
Mar. 13, 2024 (JP) 2024-038785

(51) Int. Cl. H01M 4/90; C25B 9/23; C25B 11/037; C25B 11/077; H01M 4/86; H01M 8/12; H01M 8/1231

(52) U.S. Cl. CPC H01M 4/9033; C25B 9/23; C25B 11/037; C25B 11/0773; H01M 4/8663; H01M 8/1231; H01M 2004/8689; H01M 2008/1293

(57) ABSTRACT

An electrochemical cell is disposed of a fuel electrode layer, a solid electrolyte layer, and an air electrode layer, in this order. The air electrode layer includes a plurality of catalyst particles for an air electrode which is composed of a catalyst material, a plurality of electrolyte particles for the air electrode which is composed of a solid electrolyte material, and at least one pore. The catalyst material has a coefficient of linear thermal expansion at 700° C. within a range of greater than 15x10⁻⁶/K and less than 30x10⁻⁶/K. When a first total surface area of the catalyst particles is S_{cat}, and a second total surface area of an interface portion where a first surface of the catalyst particles is in contact with a second surface of the electrolyte particles is S_{cat-ele}, the air electrode lay has a value of S_{cat-ele}/S_{cat} of 0.6 or more.

### CROSS-REFERENCE TO RELATED APPLICATION

This application is based on and claims the benefit of priority from earlier Japanese Patent Application No. 2024-038785, filed in Japan on 13 Mar. 2024, the description of which is hereby incorporated by reference.

### BACKGROUND

### 1. Technical Field

The present disclosure relates to an electrochemical cell.

### 2. Related Art

There is an electrochemical cell that has a solid electrolyte layer having oxide ion conductivity. The electrochemical cell of this type includes a solid oxide fuel cell (SOFC), a solid oxide electrochemical cell (SOEC), or the like.

### SUMMARY

The present disclosure provides an electrochemical cell. As an aspect of the technology of the present disclosure, an electrochemical cell includes a fuel electrode layer, to which fuel is supplied, a solid electrolyte layer having oxygen ion conductivity, and an air electrode layer, which is a counter electrode to the fuel electrode layer. The fuel electrode layer, solid electrolyte layer, and air electrode layer are disposed in this order. In the electrochemical cell, the air electrode layer is configured to include a plurality of catalyst particles for an air electrode, a plurality of electrolyte particles for the air electrode, and at least one pore. The plurality of catalyst particles for the air electrode is composed of a catalyst material having electron conductivity and oxygen ion conductivity. The plurality of electrolyte particles for the air electrode is composed of a solid electrolyte material having oxygen ion conductivity. The air electrode catalyst material has a coefficient of linear thermal expansion at 700° C. within a range of greater than 15×10⁻⁶/K and less than 30×10⁻⁶/K. When a first total surface area of the catalyst particles for the air electrode for the air electrode is S_{cat} and a second total surface area of an interface portion where a first surface of the catalyst particles for the air electrode is in contact with a second surface of the electrolyte particles for the air electrode is S_{cat-ele}, the air electrode layer is configured to have a value of S_{cat-ele}/S_{cat} of 0.6 or more.

### BRIEF DESCRIPTION OF THE DRAWINGS

In the accompanying drawings:

FIG. 1 is a schematic illustration of a microstructure of an electrochemical cell according to an embodiment;

FIG. 2 is a schematic illustration of an example of a laminated structure of the electrochemical cell according to the embodiment;

FIG. 3 is a diagram showing an example of a cross-section (SEM image) in a thickness direction of an air electrode layer in the electrochemical cell according to the embodiment;

FIG. 4 is a diagram showing an example of a continuous cross-sectional image perpendicular to the thickness direction of the air electrode layer, which is obtained when calculating a value of S_{cat-ele}/S_{cat} in the air electrode layer in the electrochemical cell according to the embodiment;

FIG. 5 is a diagram showing an example of an air electrode layer model (DT model) which is obtained when calculating the value of S_{cat-ele}/S_{(cat)} in the air electrode layer in an electrochemical cell according to the embodiment;

FIG. 6A is a diagram showing an example of an 8-bit grayscale SEM image obtained when measuring, using image analysis, a porosity of the air electrode layer in the electrochemical cell according to the embodiment;

FIG. 6B is a diagram showing an example of an SEM image after executing a three-value data conversion process, which is obtained when measuring, using image analysis, the porosity of the air electrode layer in the electrochemical cell according to the embodiment;

FIG. 7 is a diagram to explain a threshold setting while executing the three-value data conversion process when measuring, using image analysis, the porosity of the air electrode layer in the electrochemical cell according to the embodiment;

FIG. 8 is a diagram to explain an analysis region for Raman analysis (analysis by Raman Spectroscopy) when measuring a content ratio of Co₃O₄ in the air electrode layer in the electrochemical cell according to the embodiment;

FIG. 9 is a diagram showing an example of a Co₃O₄ detection position map generated for the analysis area shown in FIG. 8;

FIG. 10A is a diagram showing an example of a Raman spectrum when Co₃O₄ is not detected, obtained by Raman analysis, when measuring the content ratio of Co₃O₄ in the air electrode layer in the electrochemical cell according to the embodiment;

FIG. 10B is a diagram showing an example of the Raman spectrum when Co₃O₄ is detected, obtained by Raman analysis, when measuring the content ratio of Co₃O₄ in the air electrode layer in the electrochemical cell according to the embodiment;

FIG. 11A is a diagram to explain the Raman spectrum when Co₃O₄ is not detected, obtained by Raman analysis, when measuring the content ratio of Co₃O₄ in the air electrode layer in the electrochemical cell according to the embodiment;

FIG. 11B is a diagram to explain a method of generating a Co₃O₄ detection position map from the Raman spectrum when Co₃O₄ is detected, obtained by Raman analysis, when measuring the content ratio of Co₃O₄ in the air electrode layer in the electrochemical cell according to the embodiment;

FIG. 12A is a diagram to explain a method of measuring section lengths Lₚₒᵣₑ, Loat, and Lₑₗₑ in the air electrode layer in the electrochemical cell according to the embodiment, and is a diagram showing the example of the SEM image after executing the three-value data conversion process;

FIG. 12B is a diagram to explain a method of measuring the section lengths Lₚₒᵣₑ, L_{cat}, and Lₑₗₑ in the air electrode layer in the electrochemical cell according to the embodiment, and is a diagram showing an enlarged view of an area enclosed by a square shown in FIG. 12A;

FIG. 13 is a diagram to explain a relationship between the section lengths L_{cat}, Lₑₗₑ, and Lₚₒᵣₑ in the air electrode layer in the embodiment according to the embodiment; and

FIG. 14 is a diagram showing a relationship between the porosity of the air electrode layer (%) (horizontal axis) and an initial resistance of the electrochemical cell (Q) (vertical axis) obtained in experimental cases.

### DETAILED DESCRIPTION OF THE PREFERRED EMBODIMENTS

For example, Japanese Unexamined Patent Application Publication No. 2018-73653 (hereinafter referred to as JP 2018-73653 A) discloses an electrochemical cell with an electrolyte layer, an air electrode (cathode), a fuel electrode (anode), and an intermediate layer. The electrolyte layer contains a solid oxide. The air electrode is placed on a first face of the electrolyte layer and contains an air electrode material. The fuel electrode is placed on a second face of the electrolyte layer. The intermediate layer is placed between the electrolyte layer and the air electrode and includes a solid electrolyte material having oxide ion conductivity and an air electrode material. In the electrochemical cell, a difference between the coefficient of thermal expansion of the air electrode material and the coefficient of thermal expansion of the solid electrolyte material becomes 5×10⁻⁶/K or more in a temperature range from room temperature to 1000° C.

Conventional technologies have the following issues. In the electrochemical cell described in JP 2018-73653 A, the intermediate layer containing the solid electrolyte material and the air electrode material is placed between the electrolyte layer and the air electrode. Consequently, the technology in JP 2018-73653 A can suppress the occurrence of delamination in the air electrode even when the air electrode is composed of a material having a high coefficient of thermal expansion. However, even with the technology in JP 2018-73653 A, cracking occurs due to thermal expansion of a catalyst material in the electrochemical cell with an air electrode containing the catalyst material having the high coefficient of thermal expansion. Therefore, it is difficult to suppress mechanical deterioration (e.g., cracking) of the air electrode. Additionally, mechanical degradation of the air electrode leads to voltage variations in the cell, thus, affecting the achievement of long-term durability.

The present disclosure has been made in view of circumstances and has an object of providing an electrochemical cell capable of suppressing mechanical deterioration of an air electrode layer and suppressing voltage variations in the cell to achieve long-term durability.

As an aspect of the technology of the present disclosure, an electrochemical cell includes: a fuel electrode layer, to which fuel is supplied, a solid electrolyte layer having oxygen ion conductivity, and an air electrode layer, which is a counter electrode to the fuel electrode layer. The fuel electrode layer, solid electrolyte layer, and air electrode layer are disposed in this order.

In the electrochemical cell, the air electrode layer is configured to include a plurality of catalyst particles for an air electrode, a plurality of electrolyte particles for the air electrode, and at least one pore.

The plurality of catalyst particles for the air electrode is composed of a catalyst material having electron conductivity and oxygen ion conductivity. The plurality of electrolyte particles for the air electrode is composed of a solid electrolyte material having oxygen ion conductivity. The air electrode catalyst material has a coefficient of linear thermal expansion at 700° C. within a range of greater than 15×10⁻⁶/K and less than 30×10⁻⁶/K.

When a first total surface area of the catalyst particles for the air electrode for the air electrode is S_{cat} and a second total surface area of an interface portion where a first surface of the catalyst particles for the air electrode is in contact with a second surface of the electrolyte particles for the air electrode is S_{cat-ele}, the air electrode layer is configured to have a value of S_{cat-ele}/S_{cat} of 0.6 or more.

The electrochemical cell of the present disclosure has the structure above. In the air electrode layer of the above electrochemical cell, the first surface of the catalyst particles for the air electrode, which are composed of the air electrode catalyst material having the above coefficient of linear thermal expansion, is in contact with the second surface of the electrolyte particles for the air electrode so as to satisfy 0.6<S_{cat-ele}/S_{cat} (the catalyst particles are covered (wrapped) by the electrolyte particles). According to the above electrochemical cell, even if the catalyst particles for the air electrode attempt to expand thermally, the electrolyte particles for the air electrode suppresses the thermal expansion by serving as a framework. Hence, the above electrochemical cell can suppress mechanical degradation of the air electrode layer. As a result, the above electrochemical cell can suppress voltage variations in the cell, achieving long-term durability.

The reference signs described in the claims, the means to solve problems, or the like, indicate the correspondence with specific means described in embodiments described below. Thus, the reference signs do not limit the technical scope of the present disclosure.

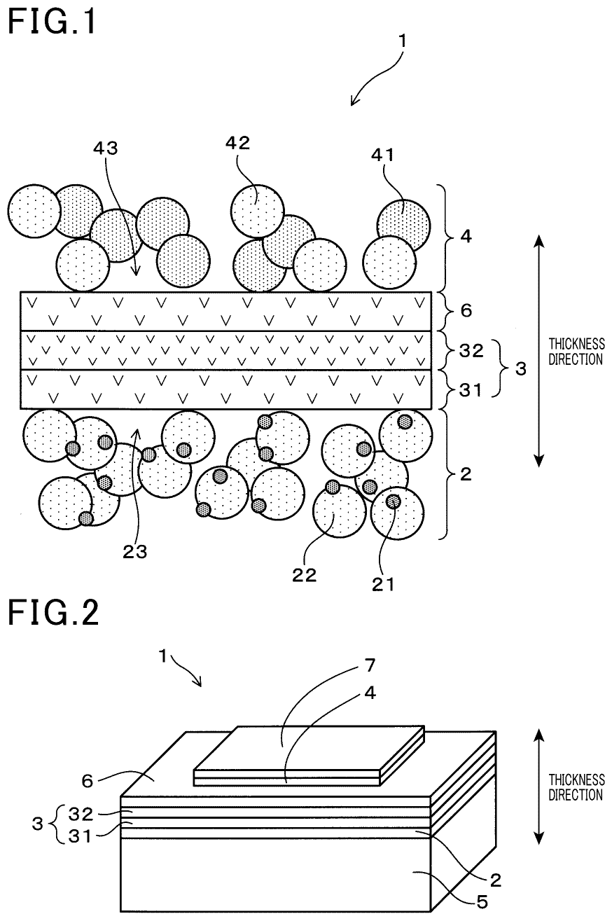

Hereinafter, embodiments of an electrochemical cell will be described with reference to the drawings such as FIGS. 1 through 13. In order to make it easier to understand the description, the same components are denoted by the same reference signs as much as possible in each drawing, and redundant descriptions are omitted.

As shown in FIGS. 1 and 2, an electrochemical cell 1 according to an embodiment provides with a fuel electrode layer (anode layer) 2, a solid electrolyte layer 3, and an air electrode layer (cathode layer) 4 in that order. In FIGS. 1 and 2, the fuel electrode layer 2 is positioned on a first surface (one side) of the solid electrolyte layer 3. The air electrode layer 4 is positioned on a second side (other side opposite to one side in a thickness direction) of the solid electrolyte layer 3. Specifically, the fuel electrode layer 2, solid electrolyte layer 3, and air electrode layer 4 are laminated in this order along a thickness direction of the electrochemical cell 1. The fuel electrode layer 2 and the solid electrolyte layer 3 are bonded to each other. FIGS. 1 and 2 show an example where the solid electrolyte layer 3 and the air electrode layer 4 are bonded through an intermediate layer 6 (described below). The fuel electrode layer 2 is configured as an electrode to which fuel is supplied. In other words, the fuel electrode layer 2 corresponds to an electrode layer with electrode activity, which functions as a fuel electrode. The air electrode layer 4 is configured as a counter electrode to the fuel electrode layer 2. In other words, the air electrode layer 4 corresponds to an electrode layer with electrode activity, which functions as an air electrode. As shown in FIGS. 1 and 2, the electrochemical cell 1 may have a flat-plate cell structure. Although not shown in the figure, the electrochemical cell 1 may have a cylindrical cell structure.

In the electrochemical cell 1, the solid electrolyte layer 3 has oxygen ion conductivity. As shown in FIGS. 1 and 2, the solid electrolyte layer 3 may be composed of multiple layers. Although not shown in the figure, the solid electrolyte layer 3 may also be a single layer. FIGS. 1 and 2 show an example in which the solid electrolyte layer 3 has two layers: an electrolyte body layer 31 and an electron blocking layer 32 formed on the side of the air electrode layer 4 of the electrolyte body layer 31. The electrolyte body layer 31 is configured as an electrolyte layer that forms a body of the solid electrolyte layer 3, and functions as the electrolyte of the electrochemical cell 1. If the solid electrolyte layer 3 has a single layer, that single layer corresponds to the electrolyte body layer 31. The electron blocking layer 32 is configured as a layer to block the transfer of electrons. When the solid electrolyte layer 3 includes the electron blocking layer 32, the transfer of electrons is blocked by the electron blocking layer 32. Therefore, in addition to having oxygen ion conductivity, the electrolyte body layer 31 may also have electronic conductivity, for example, under a reducing atmosphere. As described above, the solid electrolyte layer 3 may be configured to function as the electrolyte of the electrochemical cell 1, and the composition of the layer is not particularly limited.

As shown in FIG. 2, the electrochemical cell 1 is configured to have a fuel electrode support layer 5 on the opposite side of the fuel electrode layer 2 to the solid electrolyte layer 3, in the thickness direction of the electrochemical cell 1. The fuel electrode support layer 5 is configured as a layer to support other layers. When the electrochemical cell 1 incorporates the fuel electrode support layer 5, it becomes easier to ensure the strength and handling of the electrochemical cell 1. As shown in FIG. 2, the fuel electrode support layer 5 may support the fuel electrode layer 2, or the like, in contact with them. Although not shown in the figure, the fuel electrode support layer 5 may support the fuel electrode layer 2, or the like, via other layers positioned between the fuel electrode layer 2 and itself. The other layers include, for example, a fuel electrode diffusion layer to diffuse the fuel supplied to the fuel electrode layer 2. The fuel electrode support layer 5 described above may not only function as a support but, for example, may also be configured to allow fuel diffusion. In this case, the fuel electrode diffusion layer as the other layer described above is not necessary. The fuel electrode support layer 5 and the fuel electrode diffusion layer described above are configured to serve as a current collector for the fuel electrode layer 2.

As shown in FIGS. 1 and 2, the electrochemical cell 1 is configured to position the intermediate layer 6 between the solid electrolyte layer 3 and the air electrode layer 4, in the thickness direction of the electrochemical cell 1. The intermediate layer 6 is configured to mainly function as a layer (reaction suppression layer) to suppress a reaction between a material of the solid electrolyte layer 3 and a material of the air electrode layer 4. FIGS. 1 and 2 show an example where the intermediate layer 6 is in contact with the solid electrolyte layer 3 and the air electrode layer 4 and bonded to them.

As shown in FIG. 2, the electrochemical cell 1 is configured to have an air electrode current collecting layer 7 on the opposite side of the air electrode layer 4 to the solid electrolyte layer 3, in the thickness direction of the electrochemical cell 1. The air electrode current collecting layer 7 is configured to function as a current collector for the air electrode layer 4.

In the electrochemical cell 1, a thickness of the fuel electrode layer 2 can be, for example, within a range of 10 μm or more and 100 μm or less. A thickness of the solid electrolyte layer 3 can be, for example, within a range of 2 μm or more and 20 μm or less. A thickness of the electrolyte body layer 31 can be, for example, within a range of 1 μm or more and 15 μm or less. A thickness of the electron blocking layer 32 can be, for example, within a range of 1 μm or more and 15 μm or less. A thickness of the air electrode layer 4 can be, for example, within a range of 10 μm or more and 100 μm or less. A thickness of the fuel electrode support layer 5 can be, for example, within a range of 100 μm or more and 800 μm or less. A thickness of the intermediate layer 6 can be, for example, within a range of 1 μm or more and 20 μm or less. A thickness of the air electrode current collecting layer 7 can be, for example, within a range of 1 μm or more and 100 μm or less.

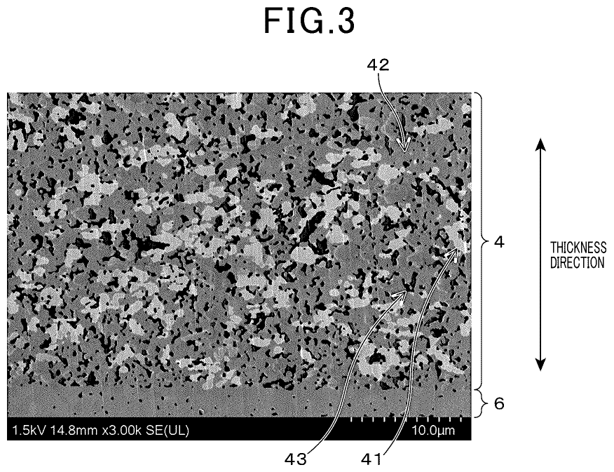

In the electrochemical cell 1 having the laminated structure described above, the air electrode layer 4 includes a plurality of catalyst particles 41 for the air electrode (hereinafter referred to as air electrode catalyst particles 41), a plurality of electrolyte particles 42 for the air electrode (hereinafter referred to as air electrode electrolyte particles 42), and one or more pores 43 (that is, at least one pore 43), as shown in FIGS. 1 and 3.

In the air electrode layer 4, the air electrode catalyst particles 41 are composed of a catalyst material (hereinafter referred to as air electrode catalyst material) having electron conductivity and oxygen ion conductivity. The air electrode catalyst material composing the air electrode catalyst particles 41 is a material in which a coefficient of linear thermal expansion (CTE) is within a range of greater than 15×10⁻⁶/K and less than 30×10⁻⁶/K at 700° C. The air-electrode catalyst material having a coefficient of the linear thermal expansion of 15×10⁻⁶/K or less at 700° C. corresponds to a material having a low coefficient of linear thermal expansion. Therefore, even if an electrochemical cell does not meet a requirement of a range of S_{cat-ele}/S_{cat} specified in the present disclosure (details are described below), cracking from thermal expansion of the air electrode catalyst material does not occur due to its low coefficient of linear thermal expansion. Thus, mechanical deterioration of the air electrode layer 4 is suppressed. Therefore, in the electrochemical cell 1 of the present disclosure, the air electrode catalyst material composing the air electrode catalyst particles 41 is assumed to have a material having a coefficient of linear thermal expansion of greater than 15×10⁻⁶/K at 700° C. The air electrode catalyst material having a coefficient of linear thermal expansion of 30×10⁻⁶/K or more at 700° C. corresponds to a material having a high coefficient of linear thermal expansion. Therefore, even if an electrochemical cell meets a requirement of a range of S_{cat-ele}/S_{cat} specified in the present disclosure, cracking from thermal expansion of the air electrode catalyst material occurs due to its high coefficient of linear thermal expansion. Thus, mechanical deterioration of the air electrode layer 4 cannot be suppressed. Therefore, in the electrochemical cell 1 of the present disclosure, the air electrode catalyst material composing the air electrode catalyst particles 41 is assumed to have a material with the coefficient of linear thermal expansion of less than 30×10⁻⁶/K at 700° C. In other words, the present disclosure states that when the coefficient of linear thermal expansion is greater than 15×10⁻⁶/K at 700° C., the coefficient of linear thermal expansion is enough to cause mechanical deterioration (e.g., cracking) in the air electrode layer 4. The technology of the present disclosure provides a specific structure in which the air electrode catalyst particles 41 composed of the air electrode catalyst material having the coefficient of linear thermal expansion within a range of greater than 15×10⁻⁶/K and less than 30×10⁻⁶/K at 700° C. suppresses thermal expansion as a framework of the air electrode electrolyte particles 42.

The air electrode catalyst material can preferably have a lower limit value of the coefficient of linear thermal expansion at 700° C. of 15.5×10⁻⁶/K or more, more preferably 16×10⁻⁶/K or more, more preferably 16.5×10⁻⁶/K or more, even more preferably 17×10⁻⁶/K or more, from the viewpoint of obtaining sufficient effects due to the technology of the present disclosure, for example, suppressing cracking caused by thermal expansion of the air electrode catalyst material. The air electrode catalyst material can preferably have an upper limit value of the coefficient of linear thermal expansion at 700° C. of 29×10⁻⁶/K or less, more preferably 28×10⁻⁶/K or less, more preferably 27×10⁻⁶/K or less, more preferably 26×10⁻⁶/K or less, more preferably 25×10⁻⁶/K or less, even more preferably 24×10⁻⁶/K or less, from the viewpoint of obtaining sufficient effects due to the technology of the present disclosure, for example, suppressing cracking caused by thermal expansion of the air electrode catalyst material. These values (upper and lower limit values) can be combined as desired.

The coefficient of linear thermal expansion of the air electrode catalyst material can be measured by the following method. First, a crystal structure of the air electrode catalyst particles 41 in the air electrode layer 4 is identified by X-ray diffraction (XRD), and contained elements are identified by energy dispersive X-ray spectroscopy (EDS). This allow the air electrode catalyst material to be identified. Then, thermo-mechanical analysis (TMA) according to JIS R 1618:2002 (measuring method of thermal expansion of fine ceramics by thermo-mechanical analysis) is performed on the identified air electrode catalyst material to measure the coefficient of linear thermal expansion. This allows the coefficient of linear thermal expansion of the air electrode catalyst material to be measured. Conditions during thermo-mechanical analysis in the present disclosure are as follows: temperature range: from room temperature to 900° C.; temperature increase rate: 5° C./min; sample dimensions: 20 mm×5 mm×1.5 mm; atmosphere: air; and load control: maintained at a constant load of 5 gf.

Examples of the air electrode catalyst material include: a perovskite-type oxide containing La, Sr, and Co; a perovskite-type oxide containing Pr, Ba, and Co; a perovskite-type oxide containing Gd, Ba, and Co; a perovskite-type oxide containing Nd, Ba, and Co, or the like. One or more of these can be used together. As the air electrode catalyst material, for example, the perovskite-type oxide containing La, Sr, and Co can be used from the viewpoints of excellent mixed conductivity where both electron conductivity and oxygen ion conductivity coexist, ensuring high catalytic activity (high electrode activity), ease of achieving the coefficient of linear thermal expansion, and the like. The perovskite-type oxide containing La, Sr, and Co described above includes, specifically, metal oxides represented by La_{0.6}Sr_{0.4}CoO₃, La₁₋ₓSrₓCoO₃₋₆ (where 0<x<1, preferably, 0.1<x<0.5), or the like. The perovskite-type oxide containing Pr, Ba, and Co includes, specifically, metal oxides represented by Pr₂₋ₓBaₓCo₂O_{5+δ} (where 0.7<x<1.3, preferably 0.8<x<1). The perovskite-type oxide containing Gd, Ba, and Co includes, specifically, metal oxides represented by Gd₂₋ₓBaₓCo₂O_{5+δ} (where 0.7<x<1.3, preferably 0.8<x<1). The perovskite-type oxide containing Nd, Ba, and Co includes, specifically, metal oxides represented by Nd₂₋ₓBaₓCo₂O_{5+δ} (where 0.7<x<1.3, preferably 0.8<x<1). The oxides described above may or may not have oxygen nonstoichiometry. The crystal structure of the air electrode catalyst material can be measured by XRD, and the elements in the oxide can be measured by EDS.

In the air electrode layer 4, the air electrode electrolyte particles 42 are composed of a solid electrolyte material having oxygen ion conductivity. The solid electrolyte material composing the air electrode electrolyte particles 42 includes, for example, ceria (CeO₂) (hereinafter referred to as Ce and RE-containing oxides) doped with one or more elements selected from Gd, Sm, Y, Sc, La, Nd, Yb, Ca, and Ho (these elements are hereinafter collectively referred to as REEs (rare-earth elements)), ceria, or the like. One or more of these can be used together. As the solid electrolyte material composing the air electrode electrolyte particles 42, ceria doped with at least one of Gd and Sm, preferably ceria doped with Gd, can be used from the viewpoint of excellent oxygen ion conductivity at a relatively low temperature of amount 700° C. The Ce and RE-containing oxides described above specifically include, for example, Ce₁₋ₓ(RE)ₓO_{2-x/2} (where 0.05<x<0.2 and the REEs are one or more elements selected from Gd, Sm, Y, Sc, La, Nd, Yb, Ca, and Ho, preferably at least one of Gd and Sm, more preferably Gd). The oxides described above may or may not have oxygen nonstoichiometry.

In the air electrode layer 4, when a total surface area of the air electrode catalyst particles 41 is S_{cat} and a total surface area of an interface portion where a surface of the air electrode catalyst particles 41 is in contact with a surface of the air electrode electrolyte particles 42 is S_{cat-ele}, a value of S_{cat-ele}/S_{cat} becomes greater than or equal to 0.6. In the following description, the total surface area of the air electrode catalyst particles 41 (S_{cat}) is referred to as a first total surface area. The surface of the air electrode catalyst particles 41 is referred to as a first surface. The surface of the air electrode electrolyte particles 42 is referred to as a second surface. The total surface area S_{cat-ele} of the interface portion where the first surface of the air electrode catalyst particles 41 is in contact with the second surface of the air electrode electrolyte particles 42 is referred to as a second total surface area.

The value of S_{cat-ele}/S_{cat} becomes a metric indicated by a ratio of the second total surface area S_{cat-ele} of the interface portion where the first surface of the air electrode catalyst particles 41 is in contact with the second surface of the air electrode electrolyte particles 42 to the first total surface area S_{cat} of the first total surface area of the air electrode catalyst particles 41. In other words, the value of S_{cat-ele}/S_{cat} is a metric that indicates the extent to which the first surface of the air electrode catalyst particles 41 is covered (wrapped) by the second surface of the air electrode electrolyte particles 42 in the air electrode layer 4. Thus, the value of S_{cat-ele}/S_{cat} greater than or equal to 0.6 (0.6<S_{cat-ele}/S_{cat}) indicates that an area of 60% or more of the first total surface area of the air electrode catalyst particles 41 is covered (wrapped) by the air electrode electrolyte particles 42. That is to say, in the air electrode layer 4, the value of S_{cat-ele}/S_{cat} is within a range of 0.6 or more and less than 1.0. When the value of S_{cat-ele}/S_{cat} is less than 0.6 (S_{cat-ele}/S_{cat}<0.6) in the air electrode layer 4, there are too few air electrode electrolyte particles 42 covering the first surface of the air electrode catalyst particles 41. Therefore, thermal expansion of the air electrode catalyst particles 41, which are composed of the air electrode catalyst material having the high coefficient of linear thermal expansion described above, cannot be suppressed by the air electrode electrolyte particles 42. This results in mechanical degradation of the air electrode layer 4, and also makes it impossible to suppress voltage variations in the cell. In contrast, when the air electrode layer 4 satisfies 0.6<S_{cat-ele}/S_{cat}, even if the air electrode catalyst particles 41 attempt to expand thermally, the air electrode electrolyte particles 42 can suppress thermal expansion by serving as the framework. Therefore, the electrochemical cell 1 of the present disclosure can suppress mechanical deterioration of the air electrode layer 4 and suppress voltage variations in the cell.

In the air electrode layer 4, a lower limit value of S_{cat-ele}/S_{cat} can preferably be 0.65 or more, and even more preferably 0.7 or more, from the viewpoint of obtaining sufficient effects due to the technology of the present disclosure. An upper limit value of S_{cat-ele}/S_{cat} can preferably be 0.9 or less and even more preferably less than 0.85 or less, from the viewpoint of releasing the oxygen produced. These values (upper and lower limit values) can be combined as desired.

The value of S_{cat-ele}/S_{cat} can be calculated by the following method. First, a continuous cross-sectional image of the air electrode layer 4 is obtained using a FIB-SEM (focused ion beam—scanning electron microscopy). Next, the acquired continuous cross-sectional image of the air electrode layer 4 is modeled in three dimensions. This results in an air electrode layer model (digital twin model, hereinafter referred to as DT model). Next, a value of S_{cat-ele} and a value of S_{cat} are calculated from the air electrode layer model, and the value of S_{cat-ele} is divided by the value of S_{cat} (calculation of S_{cat-ele}/S_{cat}). This allows the value of S_{cat-ele}/S_{cat} to be calculated.

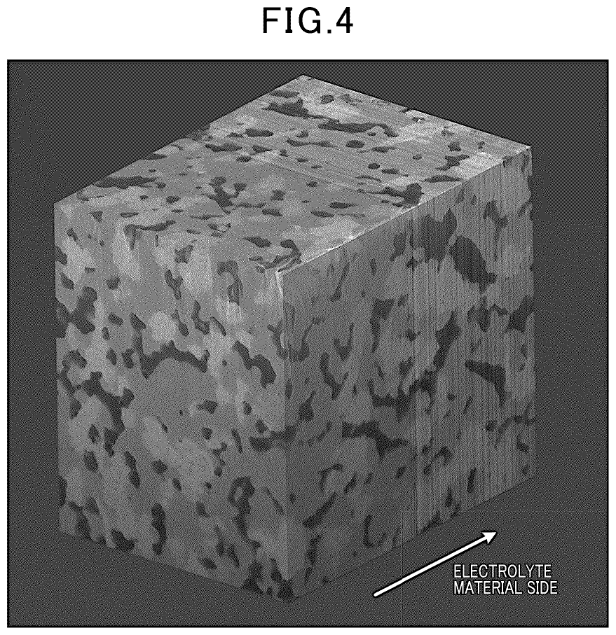

The value of S_{cat-ele}/S_{cat} can be specifically calculated as follows. An imaging area in the FIB-SEM is set so that a pore size and a particle size are at least 1/10th or less of a model size being simulated. The imaging area (imaging conditions) for the present disclosure is as follows: X-axis direction: 7.6 μm; Y-axis direction: 9.2 μm; Z-axis direction: 10.2 μm; and slice pitch: 20 nm. By using the FIB-SEM under the above imaging conditions, the continuous cross-sectional image perpendicular to the thickness direction of the air electrode layer 4 can be obtained, as shown in FIG. 4.

Next, an import Geo-Vol function is used to read the continuous cross-sectional image. In this case, the continuous cross-sectional image is read with a pixel size of one voxel when an image is captured using the FIB-SEM. The import Geo-Vol function is one of interfaces of GeoDict, microstructural simulation software developed by Math2Market GmbH. A reading condition for the present disclosure is 0.0118 μm/voxel.

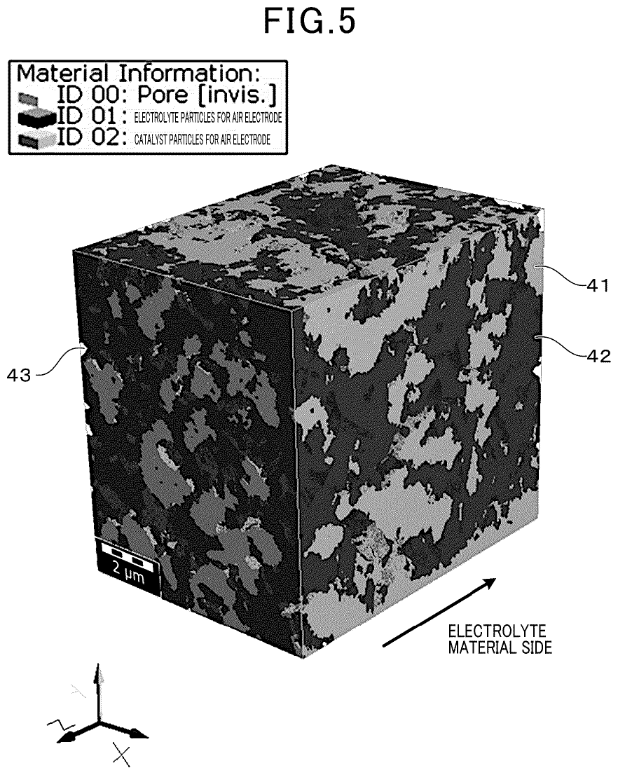

A next step is to remove an unnecessary image of the electrolyte portion from the read image for the calculation. Generally, in the FIB-SEM, brightness changes with respect to a z-axis direction. Therefore, a Gray Value Adjustment tool is used to correct luminance so that it remains constant. Next, if there are stripes due to a so-called “curtain effect”, the FIB-SEM Filters tool is used to correct the stripes. In the present disclosure, specifically, the correction is performed under conditions of Tolerance (TOL): 1e-5 and Filter Strength: 0.1. Next, suppose a material is not recognized as the same material even though it is in one particle due to noise or surface roughness. In that case, an Image Filter tool is used to perform noise processing as appropriate on the corrected image. Next, extraction is performed on any number of two-dimensional images (SEM images) obtained using the FIB-SEM (preferably ten or more two-dimensional images) for the processed three-dimensional images (three-dimensional model). Next, a threshold of a volume ratio used when executing a three-value data conversion process is determined to be the same as an average of area ratios of the particles. The three-value data conversion process is then performed. In this way, a DT model M is generated, as shown in FIG. 5.

Next, in the generated DT model M (air electrode layer model), two total surface areas are calculated using an Estimate Surface Area module. The two total surface areas are the first total surface area S_{cat} of the air electrode catalyst particles 41 and the second total surface area S_{cat-ele} of the interface portion where the first surface of the air electrode catalyst particles 41 is in contact with the second surface of the air electrode electrolyte particles 42. The Estimate Surface Area module is one of the modules of the GeoDict in the MatDict function.

Specifically, the air electrode catalyst particles 41 and the air electrode electrolyte particles 42 in the DT model M are selected as Material 1 and Material 2, respectively. A Chosen Material mode is used to calculate a total surface area of the Material 1 (total surface area S_{cat} of the air electrode catalyst particles 41). The Chosen Material mode is a mode that allows a surface area of the selected material in the Estimate Surface Area to be calculated. This mode calculates the surface area of a voxel that faces a space, among voxels of the selected Material 1 in voxels composing the DT model M. Therefore, the first total surface area S_{cat} of the air electrode catalyst particles 41 can be calculated by summing the calculated surface area. A Between Materials mode is used to calculate a total surface area of an interface portion where the Material 1 is in contact with the Material 2 (total surface area S_{cat-ele} of the interface portion where a surface of the air electrode catalyst particles 41 is in contact with a surface of the air electrode electrolyte particles 42). The Between Materials mode is a mode that allows a surface area shared between materials in the Estimate Surface Area to be calculated. This mode calculates the surface area of a portion where the voxels of the two selected Materials (voxels of the Material 1 and voxels of the Material 2) are in contact with each other (interface portion), in the voxels composing the DT model M. Therefore, the second total surface area S_{cat-ele} of the interface portion where the first surface of the air electrode catalyst particles 41 is in contact with the second surface of the air electrode electrolyte particles 42 can be calculated by summing the calculated surface area. The details of the calculation method using the Estimate Surface Area module in the GeoDict can be found in the GeoDict User's Manual. After calculating a value of S_{cat} and a value of S_{cat-ele} as described above, and the value of S_{cat-ele} is divide by the value of S_{cat} (calculation of S_{cat-ele}/S_{cat}). This allows the value of S_{cat-ele}/S_{cat} to be calculated.

The air electrode layer 4 contains one or more pores 43, as described above. In the electrochemical cell 1, from the viewpoint of increasing framework strength of the air electrode layer 4 and reducing an initial resistance of the electrochemical cell 1, a content ratio of the pores 43 (porosity of the air electrode layer 4) may be as low as possible within a numerical range that can ensure necessary gas permeability. Specifically, an upper limit value of the porosity of the air electrode layer 4 can preferably be 25% or less, more preferably 23% or less, and even more preferably 20% or less, from the viewpoint of reducing the initial resistance of the electrochemical cell 1. A lower limit value of the porosity of the air electrode layer 4 can be preferably 5% or more, more preferably 7% or more, even more preferably 10% or more, from the viewpoint of gas permeability, and the like. These values (upper and lower limit values) can be combined as desired.

The porosity of the air electrode layer 4 is defined as an area ratio of the pores 43 detected from a cross-section in the thickness direction of the air electrode layer 4. The porosity of the air electrode layer 4 can be specifically calculated by image analysis as follows.

The air electrode layer 4 of the electrochemical cell 1 is encased in resin, cured, and sectioned (specifically, processed through cross-section polishing (CP)). This results in a cross-section in the thickness direction of the air electrode layer 4. The obtained cross-section of the air electrode layer 4 is observed using a FE-SEM (field emission—scanning electron microscopy) to obtain the SEM image by reflection electron image. For the FE-SEM, for example, an “S-4800” manufactured by Hitachi High-Technologies Corporation can be used.

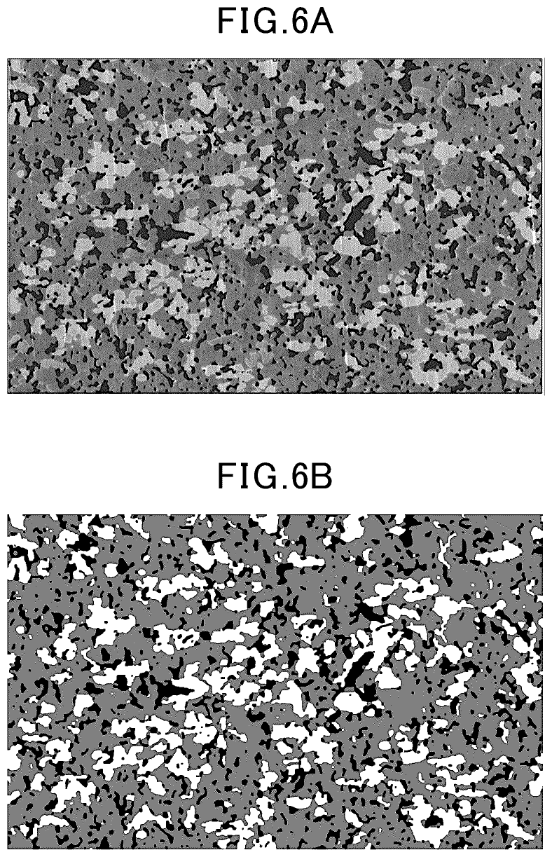

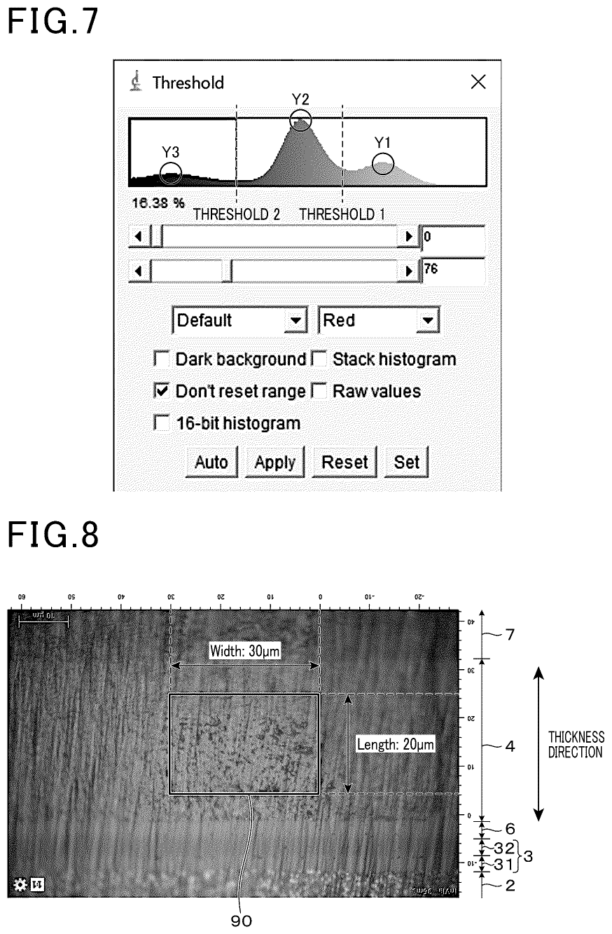

Next, the obtained SEM image is imported into image analysis software, and the imported SEM image is converted to an 8-bit grayscale SEM image, as shown in FIG. 6A. “ImageJ”, software developed by the U.S. National Institutes of Health, for example, can be used for the image analysis software. Next, using a Threshold tool in ImageJ described above, a three-value data conversion process is executed on the 8-bit grayscale SEM image. In the three-value data conversion process, a histogram of the detected intensity of the SEM image, as shown in FIG. 7, is more luminous toward a right side and less luminous toward a left side. In the histogram of the detection intensity, a midpoint between a peak of a first undulation Y1 (corresponding to a portion of the air electrode catalyst particles 41) and a peak of a second undulation Y2 (corresponding to a portion of the air electrode electrolyte particles 42) from a high luminance side is set as a threshold 1 during executing the three-value data conversion process. Next, the midpoint between the peak of the second undulation Y2 and a peak of a third undulation Y3 (corresponding to a portion of the pores 43) from the high luminance side is set as a threshold 2 during executing the three-value data conversion process. Note that the luminance varies depending on the material. Therefore, the threshold 1 and the threshold 2 are not uniquely determined. Therefore, the threshold 1 and the threshold 2 may be determined based on the material. Next, the area ratio of the pores 43 is calculated using the SEM image after executing the three-value data conversion process, as shown in FIG. 6B. The porosity can be specifically calculated using a formula: 100×{(a total area of the pores 43)/(an area of an entire SEM image after executing the three-value data conversion process)}.

In the air electrode layer 4, a lower limit value of a content ratio of the air electrode electrolyte particles 42 can preferably be 50% or more, more preferably 52% or more, and even more preferably 55% or more, from the viewpoints of increasing the framework strength of the air electrode layer 4 by the air electrode electrolyte particles 42, more easily suppressing mechanical deterioration, and the like. An upper limit value of the content ratio of the air electrode electrolyte particles 42 can preferably be 70% or less, more preferably 65% or less, and even more preferably 60% or less, from the viewpoint of maintaining an appropriate content of the air electrode catalyst particles 41. The content of the air electrode electrolyte particles 42 is defined as an area ratio of the air electrode electrolyte particles 42 detected from the cross-section in the thickness direction of the air electrode layer 4. The content ratio of the air electrode electrolyte particles 42 can be calculated similarly to the porosity of the air electrode layer 4, using the SEM image after executing the three-value data conversion process, as shown in FIG. 6B. The content ratio of the air electrode electrolyte particles 42 can be specifically calculated using a formula: 100×{(a total surface area of the air electrode electrolyte particles 42)/(the area of the entire SEM image after executing the three-value data conversion process)}.

In the air electrode layer 4, an upper limit value of the content ratio of air electrode catalyst particles 41 can preferably be 35% or less, more preferably 33% or less, and even more preferably 30% or less, from the viewpoint of ensuring oxygen ion conductivity by the air electrode electrolyte particles 42. A lower limit value of the content ratio of the air electrode catalyst particles 41 can preferably be 15% or more, more preferably 18% or more, and even more preferably 20% or more, from the viewpoint of ensuring catalytic activity (electrode activity) and electron conductivity of the air electrode layer 4. These values (upper and lower limit values) can be combined as desired. The content ratio of the air electrode catalyst particles 41 is defined as an area ratio of the air electrode catalyst particles 41 detected from the cross-section in the thickness direction of air electrode layer 4. The content ratio of the air electrode catalyst particles 41 can be calculated similarly to the porosity of the air electrode layer 4, using the SEM image after executing the three-value data conversion process, as shown in FIG. 6B. The content ratio of the air electrode catalyst particles 41 can be specifically calculated using a formula: 100×{(a total surface area of the air electrode catalyst particles 41)/(the area of the entire SEM image after executing the three-value data conversion process)}.

In the air electrode layer 4, when the air electrode catalyst material is the perovskite-type oxide containing La, Sr, and Co, and the content ratio of the air electrode catalyst particles 41 is 35% or less, the air electrode catalyst particles 41, which are composed of the air electrode catalyst material that can exhibit a high catalytic capacity, can be contained within a numerical range of the above content ratio. A high content ratio of the air electrode electrolyte particles 42 can be ensured by containing the air electrode electrolyte particles 42 within the numerical range of the above content ratio. Therefore, according to the above structure, the electrochemical cell 1 has technical advantages such as an easier reduction of the initial resistance.

In the air electrode layer 4, when the air electrode catalyst material is the perovskite-type oxide containing La, Sr, and Co, a content ratio of Co₃O₄ may preferably be 10% or less. The perovskite-type oxide containing La, Sr, and Co can exhibit high catalytic capacity. However, the perovskite-type oxide containing La, Sr, and Co is chemically decomposed to form Co₃O₄ when fired (baked) at a high temperature for a long duration during production of the air electrode layer 4, aiming to reduce the pores 43 (to increase density). Therefore, catalytic activity (electrode activity) of the air electrode layer 4 decreases due to the above decomposition. The content ratio of Co₃O₄ is a metric that indicates a degree of the decomposition of the perovskite-type oxide containing La, Sr, and Co when the air electrode catalyst material is the perovskite-type oxide containing La, Sr, and Co. When the content ratio of Co₃O₄ is 10% or less, the decomposition of the perovskite-type oxide containing La, Sr, and Co is suppressed. This makes it easier to control an increase in the resistance of the cell. An upper limit value of the content ratio of Co₃O₄ can be preferably less than 9%, more preferably less than 8%, and even more preferably less than 7%. To reduce the content ratio of Co₃O₄, the air electrode layer 4 may preferably be fired at a high temperature for short duration during production of the air electrode layer 4. The lower the content ratio of Co₃O₄, the more desirable. Therefore, the lower limit value of the content ratio of Co₃O₄ is not particularly limited.

The content ratio of Co₃O₄ described above is defined as an area ratio of a detection region of Co₃O₄ detected from the cross-section in the thickness direction of the air electrode layer 4. The content ratio of Co₃O₄ can be specifically calculated by Raman analysis (analysis by Raman Spectroscopy) as follows.

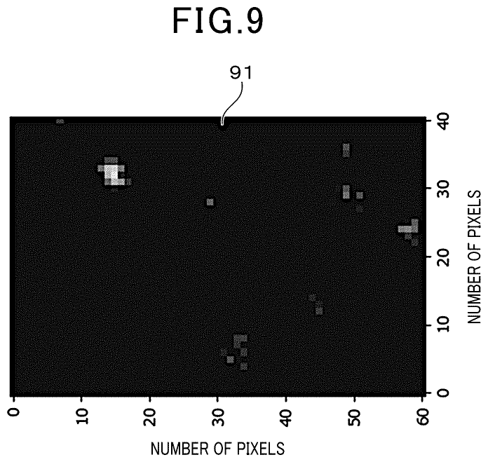

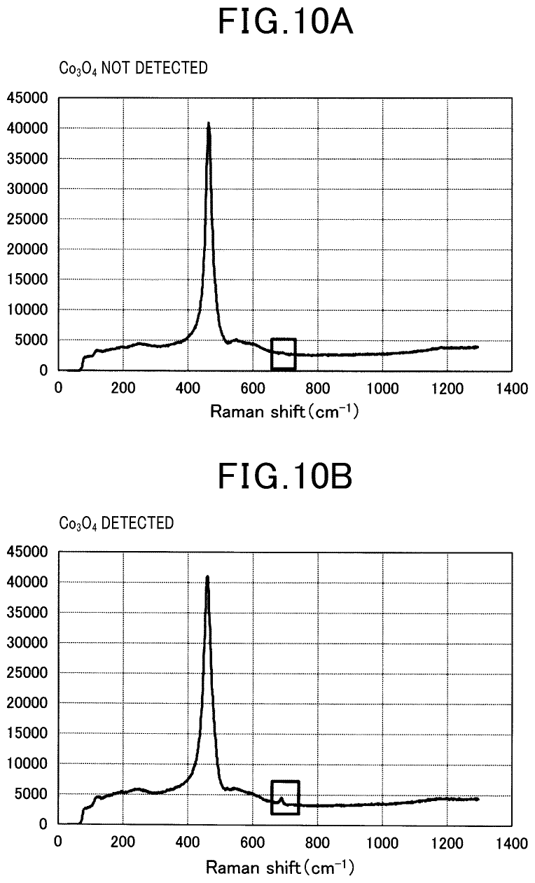

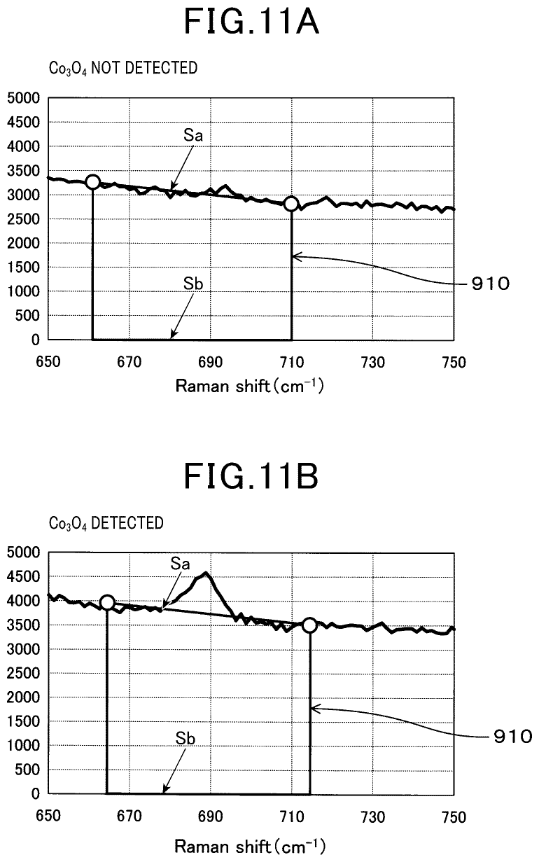

As shown in FIG. 8, the cross-section in the thickness direction of the air electrode layer 4 is obtained, and a region measuring 20 μm in length and 30 μm in width is defined within the cross-section as an analysis region 90. In an example in FIG. 8, the thickness direction corresponds to a length direction, and a direction perpendicular to the thickness direction corresponds to a width direction. Next, Raman analysis is performed on the analysis region 90, mapping a detection position of Co₃O₄ using a step width of 0.5 μm, as shown in FIG. 9; thus, a Co₃O₄ detection position map 91 is generated. In this case, one analysis point is plotted as one pixel. Thus, as shown in FIG. 9, in the Co₃O₄ detection position map 91, a total number of pixels in the length direction of the analysis region 90 is 40 pixels and a total number of the pixels in the width direction of the analysis region 90 is 60 pixels. Raman analysis is specifically performed in a numerical range of 30 cm⁻¹ and 1300 cm⁻¹ of a Raman shift per point, as shown in FIGS. 10A and 10B. FIG. 11A shows a Raman spectrum indicated in an area of a square box illustrated in FIG. 10A. FIG. 11B shows the Raman spectrum indicated in an area of a square box illustrated in FIG. 10B. Scattering intensity at 660 cm⁻¹ is set as a starting point and the scattering intensity at 710 cm⁻¹ is set as an endpoint, as shown in FIGS. 11A and 11B. An integrated area from 660 cm⁻¹ to 710 cm⁻¹ of raw data (raw values) is calculated. For each Raman spectrum obtained, a partial area of a region 910 (an area enclosed by four line segments) is calculated. The region 910 corresponds to a region between a first line segment Sa connecting the starting point and endpoint above and a second line segment Sb of an x-axis of the Raman spectrum from 660 cm⁻¹ to 710 cm⁻¹, as shown above. A value excluding the partial area from the integrated area is calculated. The partial area of the region 910 between the first-line segment Sa and the second-line segment Sb is obtained from a region of the background (dark background). When the above value calculated by excluding the partial area of the region 910 from the integrated area is greater than 0 (zero), the calculated value is used to generate the Co₃O₄ detection position map 91. On the other hand, when the above value is less than or equal to 0 (zero), it is uniformly set to 0 (zero) and the above value is assigned to the analysis point. Note that the above value is greater than 0 (zero) when there is a peak content of Co₃O₄. The above can generate the Co₃O₄ detection position map 91 indicating the detection position of Co₃O₄, as shown in FIG. 9.

Next, the generated map 91 is imported into image analysis software (ImageJ, software developed by the U.S. National Institutes of Health), and a binarization process (image thresholding) is executed on the map 91 using the Threshold tool of ImageJ described above. In the histogram of the detected intensity in the map 91, the midpoint between the peak of the first undulation and the peak of the second undulation from the high luminance side is set as the threshold during executing the binarization process. Next, an area ratio of a region with luminance to a total area of the map is calculated using the map after executing the binarization process. In other words, the area ratio of the detection area of the Co₃O₄ is calculated. The content ratio of Co₃O₄, defined as the area ratio of the detection region of Co₃O₄, can be specifically calculated using a formula: 100×{(a total area of the detection region of Co₃O₄)/(the total area of the map after executing the binarization process)}.

In a cumulative frequency distribution of each section length of the air electrode catalyst particles 41, air electrode electrolyte particles 42, and pores 43, which are detected from the cross-section in the thickness direction of the electrochemical cell 1, a section length of the air electrode catalyst particles 41 at 50% cumulative frequency is L_{cat}, a section length of the air electrode electrolyte particles 42 at 50% cumulative frequency is Lₑₗₑ, and a section length of the pores 43 at 50% cumulative frequency is Lₚₒᵣₑ. The air electrode layer 4 may preferably satisfy Lₚₒᵣₑ<L_{cat}<Lₑₗₑ. When each section length satisfies the above relationship, the size of each pore 43, which is the starting point for crack propagation, is smaller than a size of the framework formed by the air electrode electrolyte particles 42 (a size of the framework of the air electrode layer 4). In other words, when each section length satisfies the above relationship, a size of the framework formed by the air electrode electrolyte particles 42 is greater than the size of each pore 43, which is the starting point for crack propagation. Thus, mechanical strength of the air electrode layer 4 can be improved.

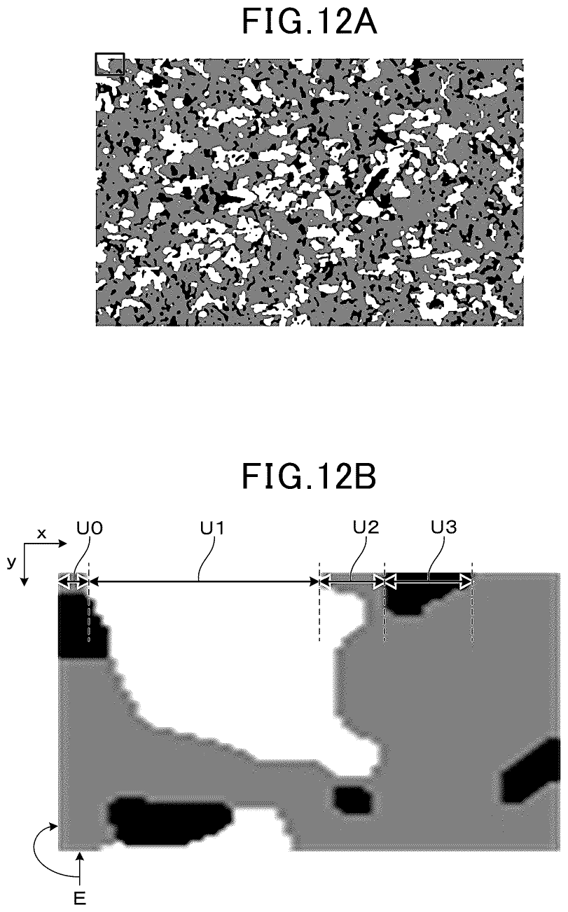

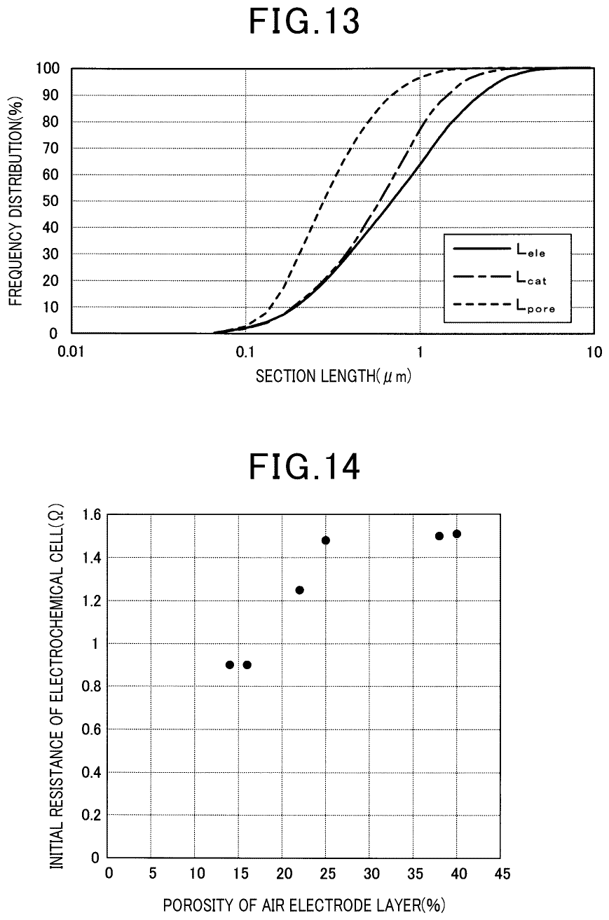

The section lengths L_{cat}, Lₑₗₑ, and Lₚₒᵣₑ can be specifically calculated as follows. As shown in FIG. 12A, the SEM image is obtained after executing the three-value data conversion process is obtained similarly to the measurement of the porosity of the air electrode layer 4. FIG. 12B shows a SEM image indicated in an area of a square box illustrated in FIG. 12A. In the following, the SEM image after executing the three-value data conversion process is referred to as a three-value data conversion image. As shown in FIG. 12B, a width direction of the three-value data conversion image is an x-axis direction and a length direction is a y-axis direction. Next, a number of pixels in consecutive section lengths of the same material is counted from a left edge to a right edge of the x-axis direction of the three-value data conversion image for the air electrode catalyst particles 41, air electrode electrolyte particles 42, and pores 43. Then, shifting in the y-axis direction by one pixel, and the number of the pixels in the consecutive section lengths of the same material from the left edge to the right edge of the x-axis direction was counted. The above first counting process is repeated from a top edge to a bottom edge of the three-value data conversion image in the y-axis direction. A number of pixels in consecutive intercept lengths of the same material from the top edge to the bottom edge of the y-axis direction of the three-value data conversion image is counted for the air electrode catalyst particles 41, the air electrode electrolyte particles 42, and the pores 43. Then, shifting in the x-axis direction by one pixel, the number of the pixels in consecutive section lengths of the same material from the top edge to the bottom edge of the y-axis direction was counted. The above second counting process is repeated from the left edge to the right edge of the three-value data conversion image in the x-axis direction. However, as shown in FIG. 12B, the top and bottom edges and the left and right edges of the three-value data conversion image include an edge E obtained from the SEM image; thus, the section length is shorter. Therefore, a number of contiguous pixels from the edge E is not used to calculate the section length. For example, in the calculation of each section length in the x-axis direction in FIG. 12B, a number of pixels in a range indicated by a sign U0 is not used in the calculation of the section length. On the other hand, each number of pixels in a range indicated by a sign U1, a range indicated by a sign U2, and a range indicated by a sign U3 is used to calculate each section length. A specific value of each section length can be calculated by converting a side length per pixel of the three-value data conversion image based on a magnification of the SEM and multiplying the number of the pixels of the section length by the side length per pixel. The cumulative frequency distribution of the section length of the air electrode catalyst particle 41 is then obtained, as shown in FIG. 13. As a result, the section length Lₑₐₜ of the air electrode catalyst particles 41 is a section length when the cumulative frequency accumulated from the shorter section length reaches 50%. Similarly, the cumulative frequency distribution of the section length of the air electrode electrolyte particle 42 is obtained. As a result, the section length Lₑₗₑ of the air electrode electrolyte particles 42 is a section length when the cumulative frequency accumulated from the shorter section length reaches 50%. The cumulative frequency distribution of the section length of the pore 43 is also obtained. As a result, the section length Lₚₒᵣₑ of the pores 43 is the section length when the cumulative frequency accumulated from the shorter section length reaches 50%. In the calculation of the section lengths Lₑₐₜ, Lₑₗₑ, and Lₚₒᵣₑ, all section lengths are accumulated from the one with the shorter section length, without distinguishing between the x-axis and y-axis directions described above.

In the electrochemical cell 1 described above, in the air electrode layer 4, the air electrode catalyst particles 41 are composed of the air electrode catalyst material having the coefficient of linear thermal expansion that is within the range of greater than 15×10⁻⁶/K and less than 30×10⁻⁶/K. Furthermore, the surface of the air electrode catalyst particles 41 is covered (wrapped) by the air electrode electrolyte particles 42 to ensure that the value of S_{cat-ele}/S_{cat} is 0.6 or more (0.6<S_{cat-ele}/S_{cat}). In other words, an area of 60% or more of the total surface area of the air electrode catalyst particles 41 is covered (wrapped) by the air electrode electrolyte particles 42. Thus, according to the electrochemical cell 1 of the present disclosure, even if the air electrode catalyst particles 41 attempt to expand thermally, the air electrode electrolyte particles 42 act as the framework to suppress thermal expansion. Hence, the electrochemical cell 1 of the present disclosure can suppress voltage variations in the cell by suppressing mechanical degradation of the air electrode layer 4, achieving long-term durability.

The electrochemical cell 1 of the present disclosure may be any solid oxide cell that uses a material having oxygen ion conductivity as the electrolyte. As long as the electrochemical cell 1 of the present disclosure is configured as described above, the materials and composition of the fuel electrode layer 2, solid electrolyte layer 3 (electrolyte body layer 31, electron blocking layer 32, and the like), fuel electrode support layer 5, intermediate layer 6, and air electrode current collecting layer 7, except the air electrode layer 4, are not particularly limited.

For example, as shown in FIG. 1, the fuel electrode layer 2 may be configured to include a plurality of fuel electrode catalyst particles 21, a plurality of fuel electrode electrolyte particles 22, and one or more pores 23 (that is, at least one pore 23). The fuel electrode catalyst particles 21 can be composed of, for example, a fuel electrode catalyst material having electron conductivity. The fuel electrode side electrolyte 22 can be composed of, for example, a solid electrolyte material having oxygen ion conductivity. The solid electrolyte material having oxygen ion conductivity used for the fuel electrode electrolyte particles 22 may also have electron conductivity. Alternatively, the solid electrolyte material may not have to be electron conductive.

Examples of fuel electrode catalyst materials composing the fuel electrode side catalyst particles 21 include an electron conductor (e.g., metals and alloys) such as Ni, Ni alloys, Cu, Cu alloys, Co, Co alloys, or the like, oxides of an electron conductor that become an electron conductor by reduction such as Ni oxides (e.g., NiO), Cu oxides, Co oxides, or the like. One or more of these can be used together. Ni, Ni alloys, Ni oxides (e.g., NiO), or the like, are preferably used as the fuel electrode catalyst material from the viewpoint of catalytic activity (electrode activity), and Ni, NiO, or the like, are more preferably used. Examples of the solid electrolyte material composing the fuel electrode electrolyte particles 22 include an oxide containing Ce and RE, the solid electrolyte material composing the air electrode electrolyte particles 42 described above such as ceria, or the like. Further, the examples of the solid electrolyte material composing the fuel electrode electrolyte particles 22 include yttria stabilized zirconia (YSZ), scandia stabilized zirconia (ScSZ), or the like. One or more of these can be used together. As the solid electrolyte material, for example, ceria doped with at least one of Gd and Sm may be used from the viewpoint of excellent oxygen ion conductivity at approximately 700° C. (low temperature), and more preferably, ceria doped with Gd may be suitably used.

For example, when the solid electrolyte layer 3 is configured to have the electrolyte body layer 31 and the electron blocking layer 32, as shown in FIG. 1, the electrolyte body layer 31 can be composed of a solid electrolyte material or the like, having electron conductivity and oxygen ion conductivity. The electron blocking layer 32 can be composed of a solid electrolyte material or the like that does not have electron conductivity but have oxygen ion conductivity. When the solid electrolyte layer 3 is configured by a single layer of the electrolyte body layer 31, the electrolyte body layer 31 (i.e., solid electrolyte layer 3) can be composed of a solid electrolyte material or the like that does not have electron conductivity but has oxygen ion conductivity. The solid electrolyte layer 3 is usually formed densely to prevent gas permeation.

In the solid electrolyte layer 3, examples of the solid electrolyte material having electron conductivity and oxygen ion conductivity include, for example, an oxide containing Ce and RE, the solid electrolyte material composing the air electrode electrolyte particles 42 described above such as ceria, or the like. One or more of these can be used together. As the solid electrolyte material having electron conductivity and oxygen ion conductivity, ceria doped with at least one of Gd and Sm may be used from the viewpoint of excellent oxygen ion conductivity at approximately 700° C. (low temperature), and more preferably, ceria doped with Gd may be suitably used. Examples of the solid electrolyte material that does not have electron conductivity but has oxygen ion conductivity include yttria stabilized zirconia (YSZ), scandia stabilized zirconia (ScSZ), or the like. One or more of these can be used together. As the solid electrolyte material that does not have electron conductivity but has oxygen ion conductivity, for example, yttria stabilized zirconia (YSZ) may be used from the viewpoint of being stable to a reducing atmosphere and not developing electronic conductivity.

The fuel electrode support layer 5 can be configured, for example, as a porous layer with pores or through holes so as not to prevent fuel from being supplied to the fuel electrode layer 2. The fuel electrode support layer 5 can be composed of, for example, a mixed material including the fuel electrode catalyst material described above and an oxide material, a metal (including alloys, hereinafter omitted) material, or the like. In the electrochemical cell 1 of the present disclosure, when the fuel electrode support layer 5 is composed of a metallic material, a bonding layer (not shown) may be formed between the fuel electrode support layer 5 and the fuel electrode layer 2.

In the fuel electrode support layer 5, examples of an oxide material include oxides containing Ce and RE, the solid electrolyte material composing the air electrode electrolyte particles 42 described above such as ceria, or the like. Further, examples of the oxide material include yttria stabilized zirconia (YSZ), scandia stabilized zirconia (ScSZ), or the like. One or more of these can be used together. As the oxide material, for example, ceria doped with at least one of Gd and Sm may be used from the viewpoint of excellent oxygen ion conductivity at approximately 700° C. (low temperature), and more preferably, ceria doped with Gd may be suitably used.

In the fuel electrode support layer 5, the oxide material need not be the solid electrolyte. In addition to the above, various oxide materials that are not a solid electrolyte, such as CaO, MgO, or the like, can also be used as the oxide material. In the fuel electrode support layer 5, examples of the metallic material include, for example, Fe-based alloys. In Fe-based alloys, an alloying element is added to the base metal Fe. The alloying element may contain one or more metallic elements and may also contain one or more non-metallic elements in addition to the metallic elements. The alloying element does not include Fe. The above metallic element can also include a semi-metallic element. Examples of the metallic element included in the alloying element are Cr, Mn, Ti, Ni, Al, Cu, Mo, Nb, V, La, Ta, Hf, Zr, Si, B, or the like. One or more of these can be used together. The metallic element included in the alloying element can specifically include at least Cr, and more specifically at least Cr and at least one element selected from a group containing Mn, Ti, Ni, Al, Cu, Mo, Nb, V, La, Ta, Hf, Zr, Si, and B. Among metallic elements included in the alloying element of the Fe-based alloys, a maximum additive metallic element with a largest content ratio can be, for example, one element selected from a group containing Cr, Mn, and Ti. The Fe-based alloys that contain Cr as the maximum additive metallic element are referred to as Fe—Cr alloys. Similarly, the Fe-based alloys that contain Mn as the maximum additive metallic element are referred to as Fe—Mn alloys. The Fe-based alloys that contain Ti as the maximum additive metal element are referred to as Fe—Ti alloys.

The intermediate layer 6 can be composed of a mixed material, including the solid electrolyte material having oxygen ion conductivity and an air electrode material composing the air electrode layer 4, a solid electrolyte material having oxygen ion conductivity, or the like. The solid electrolyte material having oxygen ion conductivity used in the intermediate layer 6 may also have electronic conductivity. Alternatively, the solid electrolyte material may not have to be electron conductive.

Examples of the solid electrolyte material having oxygen ion conductivity used in the intermediate layer 6 include oxides containing Ce and RE, the solid electrolyte material composing the air electrode electrolyte particles 42 described above such as ceria, or the like. Further, examples of the solid electrolyte material include yttria stabilized zirconia (YSZ), scandia stabilized zirconia (ScSZ), or the like. One or more of these can be used together. As the solid electrolyte material, ceria doped with at least one of Gd and Sm may be used from the viewpoints of excellent oxygen ion conductivity at approximately 700° C. (low temperature) and low reactivity with the air electrode catalyst material, and more preferably, ceria doped with Gd may be suitably used.

The air electrode current collecting layer 7 can be composed of an air electrode current collecting material having electron conductivity suitable for current collection in the air electrode, which is exposed to a high-temperature oxidizing atmosphere.

Examples of air electrode current collecting material include a metallic material such as Pt, Pt alloys, Ag, Ag alloys, Au, or the like, and an oxide having electronic conductivity such as the perovskite-type oxide containing La, Sr, and Co and the perovskite-type oxide containing La, Ni, and Fe, or the like. One or more of these can be used together. As the air electrode current collecting material, Pt and Pt alloys may be used in the case of the metallic material, and the perovskite-type oxide containing La, Sr, and Co may be used in the case of the oxide having electron conductivity, from the viewpoint of resistance to oxidation in a high-temperature oxidizing atmosphere, high electron conductivity, or the like.

The electrochemical cell 1 of the present disclosure is configured to be used as at least one of a solid oxide fuel cell (SOFC) and a solid oxide electrolysis cell (SOEC). In other words, the electrochemical cell 1 may serve as the SOFC. The electrochemical cell 1 may also serve as the SOEC. Furthermore, the electrochemical cell 1 may be configured to be switchable between an SOFC mode, in which it operates as the SOFC, and an SOEC mode, in which it operates as the SOEC, and may serve as the SOFC and SOEC.

Specifically, when the electrochemical cell 1 is operated as the SOFC, a hydrogen-containing gas such as hydrogen gas, for example, can be supplied to the fuel electrode layer 2 as fuel gas. In this case, an oxygen-containing gas such as air or oxygen gas can be supplied to the air electrode layer 4. On the other hand, when the electrochemical cell 1 is operated as the SOEC, the fuel electrode layer 2 functions as a hydrogen electrode. A water (H₂O)-containing gas, such as water vapor, for example, can be supplied to the fuel electrode layer 2 as the fuel gas. In this case, the air electrode layer 4 serves as the oxygen electrode. Air or other gases may be supplied to the air electrode layer 4. Alternatively, no gas may be supplied to the air electrode layer 4. The hydrogen-containing gas described above can contain water vapor for humidification, or the like. The water-containing gas can include a reducing gas such as hydrogen gas or the like.

### Experimental Example

### <Material Preparation>

### —Fuel Electrode Support Layer—

A slurry was prepared by mixing the following materials using a ball mill: NiO powder (average particle diameter: 1.0 μm), yttria stabilized zirconia (hereinafter referred to as 8YSZ) powder (average particle diameter: 0.5 μm) containing 8 mol % of Y₂O₃, carbon (pore former), polyvinyl butyral, isoamyl acetate, and 1-butanol. A mass ratio of the NiO powder to the 8YSZ powder was 65:35. A sheet used to form the fuel electrode support layer was prepared by applying a layer of the above slurry onto a resin sheet by a doctor-blade method, drying the slurry-applied resin sheet, and then peeling off the resin sheet from the dried sheet. The above average particle diameter is a particle diameter (diameter) d50 when the cumulative frequency distribution of a volume standard is 50%, as measured by a laser diffraction/scattering method.

### —Fuel Electrode Layer—

A slurry was prepared by mixing the following materials using a ball mill: NiO powder (average particle diameter: 1.0 μm), 8YSZ powder (average particle diameter: 0.5 μm), carbon (pore former), polyvinyl butyral, isoamyl acetate, and 1-butanol. The mass ratio of the NiO powder to the 8YSZ powder was 65:35. The amount of carbon in a sheet used to form the fuel electrode layer was less than that in a sheet used to form the fuel electrode support layer. Thereafter, the sheet used to form the fuel electrode layer was prepared in the same way as the sheet used to form the fuel electrode support layer.

### —Electrolyte Body Layer—

A slurry was prepared by mixing the following materials using a ball mill: Gd-doped CeO₂ (hereinafter referred to as GDC) powder (average particle diameter: 0.3 μm), polyvinyl butyral, isoamyl acetate, 2-butanol, and ethanol. In this experimental example, CeO₂ doped with 10 mol % of Gd was used as the GDC. Thereafter, the sheet used to form the electrolyte body layer was prepared in the same way as the sheet used to form the fuel electrode support layer.

### —Electron Blocking Layer—

A slurry was prepared by mixing the following materials using a ball mill: 8YSZ powder (average particle diameter: 0.5 μm), polyvinyl butyral, isoamyl acetate, and 1-butanol. Thereafter, the sheet used to form the electron blocking layer was prepared in the same way as the sheet used to form the fuel electrode support layer.

### —Intermediate Layer—

A slurry was prepared by mixing the following materials using a ball mill: GDC powder (average particle diameter: 0.3 km), polyvinyl butyral, isoamyl acetate, 2-butanol, and ethanol. In this experimental example, CeO₂ doped with 10 mol % of Gd was used as the GDC. Thereafter, the sheet used to form the intermediate layer was prepared in the same way as the sheet used to form the fuel electrode support layer.

### —Air Electrode Layer—

As shown in Table 1 below, La_{0.6}Sr_{0.4}CoO₃ powder or PrBaCo₂O₅ powder (average particle diameter selected from a numerical range of 1.0 μm or more and 2.0 μm or less) as a powder for forming the air electrode catalyst material and GDC powder (average particle diameter selected from a numerical range of 0.15 μm or more and 1.0 μm or less) as a powder for forming the solid electrolyte material were used. The above materials were mixed, then, the mixture was dispersed in terpineol as a solvent along with a dispersant. A volume ratio of the La_{0.6}Sr_{0.4}CoO₃ powder to the GDC powder was selected from a numerical range of 33 to 66:34 to 66. Ethylcellulose was added as a binder to the obtained dispersion and mixed to prepare a paste used to form the air electrode layer.

### —Air Electrode Current Collecting Layer—

La_{0.6}Sr_{0.4}CoO₃ powder (average particle diameter: 1.6 μm) and the dispersant were dispersed in the terpineol as the solvent. Ethylcellulose was added as a binder to the obtained dispersion and mixed to prepare a paste used to form the air electrode current collecting layer.

### <Production of Electrochemical Cell>

The sheet for forming the fuel electrode layer was stacked on top of multiple-stacked sheets for forming the fuel electrode support layer and then pressed and bonded by a warm isostatic pressing (WIP) molding method. Next, the sheet for forming the electrolyte body layer was stacked on top of the sheet for forming the fuel electrode layer and then pressed and bonded by the same method described above. Next, the sheet for forming the electron blocking layer was stacked on top of the sheet for forming the electrolyte body layer and then pressed and bonded by the same method described above. Next, the sheet for forming the intermediate layer was stacked on top of the sheet for forming the electron blocking layer and then pressed and bonded by the same method described above. The pressure-bonding conditions in the present disclosure were as follows: temperature: 85° C.; pressure: 50 MPa; and pressurization time: 10 minutes. The obtained pressure-bonding body was then cut to a predetermined size. The pressure-bonding bodies of the predetermined size were then fired (baked) at 1350° C. for 2 hours in atmospheric air. As a result, a ceramic substrate was obtained in which the fuel electrode support layer (thickness: 350 μm), fuel electrode layer (thickness: 30 μm), electrolyte body layer (thickness: 3 μm), electron blocking layer (thickness: 3 μm), and intermediate layer (thickness: 3 μm) are laminated in this order.

Next, the paste for forming the air electrode layer was applied to a surface of the intermediate layer on the obtained ceramic substrate by the screen printing method and fired (baked) at a predetermined temperature (temperature selected from a numerical range of 1100° C. or more and 1200° C. or less) in atmospheric air for a predetermined time (time selected from a numerical range of 5 minutes or more and 1 hour or less). This formed the air electrode layer (thickness: 50 μm). A size of an outer contour of the air electrode layer is smaller than that of the fuel electrode layer.

Next, the paste for forming the air electrode current collecting layer was applied to a surface of the air electrode layer by the screen printing method and fired (baked) at 900° C. for 2 hours in atmospheric air. This formed the air electrode current collecting layer (thickness: 50 μm).

The above steps were used to produce each flat-plate electrochemical cell (single cell) corresponding to Sample 1 to Sample 15 shown in Table 1 below. Details of modifications in production of each electrochemical cell of Samples 2 to 15 with respect to Sample 1 were as follows:
Sample 2: A material (PrBaCo₂O₅) used as the powder of the air electrode catalyst material differs from that (La_{0.6}SroACoO₃) of Sample 1;
Sample 3: An average particle diameter of the powder of the solid electrolyte material was smaller than that of Sample 1;
Sample 4: An average particle diameter of the powder of the air electrode catalyst material was smaller than that of Sample 1, and the average particle diameter of the powder of the solid electrolyte material was smaller than that of Sample 2;
Sample 5: The average particle diameter of the powder of the air electrode catalyst material was smaller than that of Sample 4, and the average particle diameter of the powder of the solid electrolyte material was smaller than that of Sample 4;
Sample 6: The average particle diameter of the powder of the solid electrolyte material was smaller than that of Sample 1, and the average particle diameter of the powder of the solid electrolyte material was larger than that of Sample 5;
Sample 7: The average particle diameter of the powder of the air electrode catalyst material was smaller than that of Sample 5, and the average particle diameter of the powder of the solid electrolyte material was smaller than that of Sample 5;
Sample 8: Compared to Sample 7, the content ratio of the powder of the air electrode catalyst material was increased (35>29), and the content ratio of the powder of the solid electrolyte material was decreased (51<57);
Sample 9: Compared to Sample 8, the content of the powder of the air electrode catalyst material was increased (44>35), and the content of the powder of the solid electrolyte material was decreased (42<51);
Sample 10: Compared to Sample 9, the content of the powder of the air electrode catalyst material was increased (56>44), and the content of the powder of the solid electrolyte material was decreased (30<42);
Sample 11: A material (PrBaCo₂O₅) used as the powder of the air electrode catalyst material differs from that (La_{0.6}Sr_{0.4}CoO₃) of Sample 7;
Sample 12: The average particle diameter of the powder of the air electrode catalyst material was smaller than that of Sample 7, the average particle diameter of the powder of the solid electrolyte material was smaller than that of Sample 7, and the firing temperature was lower than that of Sample 7;
Sample 13: The average particle diameter of the powder of the air electrode catalyst material was smaller than that of Sample 12, the average particle diameter of the powder of the solid electrolyte material was smaller than that of Sample 12, and the firing temperature was lower than that of Sample 12;
Sample 14: The average particle diameter of the powder of the air electrode catalyst material was smaller than that of Sample 13, the average particle diameter of the powder of the solid electrolyte material was smaller than that of Sample 13, the firing temperature was lower than that of Sample 13, and the firing time was shorter than that of Sample 13; and
Sample 15: The average particle diameter of the powder of the solid electrolyte material was smaller than that of Sample 14.

In Table 1, when a particle diameter of a powder of a raw material was selected so that the average particle diameter of the powder of the solid electrolyte material becomes smaller than that of the powder of the air electrode catalyst material, “Ele<Cat” is indicated. On the other hand, when the particle diameter of the powder of the raw material was selected so that the average particle diameter of the powder of the air electrode catalyst material becomes smaller than that of the solid electrolyte material, “Cat<Ele” is indicated.

Sample 1C, Sample 2C, and Sample 3C were also produced for comparison. In production of the electrochemical cell of Sample 1C, the firing temperature of the paste for forming the air electrode layer was set to a low temperature (e.g., 700° C.) within the numerical range of the above predetermined temperature. Other than this point, Sample C1 was produced in the same way as the conditions for Sample 1.

Ba_{0.6}La_{0.4}CoO₃ powder (average particle diameter: 1.0 μm) was used as the powder of the air electrode catalyst material in production of the electrochemical cell in Sample 2C. Other than this point, Sample 2C was prepared in the same way as the conditions for Sample 1.

In production of the electrochemical cell of Sample 3C, the firing temperature of the paste for forming the air electrode layer was set to a low temperature (e.g., 700° C.) within the numerical range of the above predetermined temperature. La_{0.6}Sr_{0.4}Co_{0.2}Fe_{0.8}O₃ powder (average particle diameter: 1.0 μm) was used as the powder of the air electrode catalyst material. Other than this point, Sample 3C was prepared in the same way as the conditions for Sample 1.

### <Structural Analysis of Air Electrode Layer>

For each electrochemical cell, the cross-section in the thickness direction of the air electrode layer was observed by using the SEM. As a result, it was confirmed that each air electrode layer contained multiple air electrode catalyst particles, multiple air electrode electrolyte particles, and one or more pores, as shown in FIG. 3. In accordance with the measurement method described above, the following parameters were measured in each air electrode layer: the coefficient of linear thermal expansion of the air electrode catalyst material at 700° C., the S_{cat-ele}/S_{cat}, the porosity, the content ratio of the air electrode electrolyte particles, the content ratio of the air electrode catalyst particles, the content ratio of Co₃O₄, and a relationship of Lₚₒᵣₑ<L_{cat}<Lₑₗₑ.

### <Evaluation>

### —Evaluation Preparation—

A platinum paste is applied to a surface of the fuel electrode support layer of the electrochemical cell by the screen printing method and fired (baked) at 900° C. for 1 hour in atmospheric air. This formed the fuel electrode current collecting layer (thickness: 20 μm). On an air electrode layer side of a single cell, a platinum wire as a reference electrode was fixed to a part where the air electrode layer was not formed, using the platinum paste. Next, sealing glass was coated to an end face of the electrochemical cell. The electrochemical cell coated with the sealing glass was heated to 850° C. in atmospheric air, and a fuel piping was sealed with glass on a fuel electrode layer side to form a hermetically-sealed structure. The fuel electrode layer was then subjected to a reduction process. Conditions of the reduction process were as follows: reduction temperature: 600° C., reduction process gas: hydrogen gas, and reduction time: 3 hours.

### —Evaluation Condition—

After performing the above reduction process, the temperature was slightly increased to 650° C. A mixture of hydrogen and water vapor (hydrogen:water vapor=50:50 by volume) was supplied to the fuel electrode layer and air to the air electrode layer in the electrochemical cell. In this experimental example, an initial aging process was performed by applying a constant current at a current density of 0.5 A/cm² for 50 hours. The electrochemical cell was then evaluated under the same energizing conditions.

### —Mechanical Deterioration (Cracking)—

Under the above evaluation conditions, the above mixture was supplied as fuel gas to the fuel electrode layer and air to the air electrode layer, and after 1000 hours of energization, the temperature was lowered. Samples obtained from the electrochemical cell after 1000 hours of energization were encased in resin, cured, and sectioned. As a result, the SEM image of the cross-section in the thickness direction of the air electrode layer was obtained. The presence of cracks in the air electrode layer was confirmed by the SEM image of the obtained cross-section.

### —Ratio of Voltage Variations in Cell—

The same conditions as for mechanical degradation described above were used to obtain a first cell voltage at the beginning of energization between the reference electrode and the air electrode layer (after aging) and a second cell voltage at the end of 1000 hours of energization. A ratio of voltage variations in the cell was then calculated using a formula: 100×[{(the second cell voltage at the end of 1000 hours of energization)−(the first cell voltage at the beginning of energization)}/(the first cell voltage at the beginning of energization)]. Mechanical degradation leads to increased resistance, causing the voltage to decrease during the operation of the solid oxide fuel cell (SOFC) and to increase during the operation of the solid oxide electrolytic cell (SOEC). Here, the electrochemical cell is operated as the SOFC.

### —Initial Resistance of Cell—

Once the above initial aging was completed, the initial resistance of the entire electrochemical cell was measured through AC impedance testing at an amplitude of 100 mV in a frequency range from 106 Hz to 10 Hz.

Details and evaluation results for each of the above-described air electrode layers are shown in Table 1. FIG. 14 also shows a relationship between the porosity (%) of the air electrode layer and the initial resistance (Q) of the electrochemical cell.

TABLE 1

| | Air electrode layer | | | | | |
|---|---|---|---|---|---|---|
| | Air electrode catalyst | | | | | |
| | particles | | | | | |
| | | Coefficient of | | | Content | Content |
| | | linear thermal | | | ratio of air | ratio of air |
| | Material used as | expansion of air | | | electrode | electrode |
| | powder of air | electrode catalyst | | | electrolyte | catalyst |
| Sample | electrode catalyst | material (/K) @ | S_{cat-ele}/ | Porosity | particles | particles |
| No. | material | 700° C. | S_{cat} | (%) | (%) | (%) |
| 1 | La_{0.6}Sr_{0.4}CoO₃ | 17 × 10⁻⁶ | 0.7 | 38 | 41 | 21 |
| 2 | PrBaCo₂O₅ | 24 × 10⁻⁶ | 0.7 | 38 | 41 | 21 |
| 3 | La_{0.6}Sr_{0.4}CoO₃ | 17 × 10⁻⁶ | 0.8 | 38 | 41 | 21 |
| 4 | La_{0.6}Sr_{0.4}CoO₃ | 17 × 10⁻⁶ | 0.7 | 25 | 49 | 26 |
| 5 | La_{0.6}Sr_{0.4}CoO₃ | 17 × 10⁻⁶ | 0.7 | 16 | 55 | 29 |
| 6 | La_{0.6}Sr_{0.4}CoO₃ | 17 × 10⁻⁶ | 0.7 | 22 | 51 | 27 |
| 7 | La_{0.6}Sr_{0.4}CoO₃ | 17 × 10⁻⁶ | 0.7 | 14 | 57 | 29 |
| 8 | La_{0.6}Sr_{0.4}CoO₃ | 17 × 10⁻⁶ | 0.7 | 14 | 51 | 35 |
| 9 | La_{0.6}Sr_{0.4}CoO₃ | 17 × 10⁻⁶ | 0.7 | 14 | 42 | 44 |
| 10 | La_{0.6}Sr_{0.4}CoO₃ | 17 × 10⁻⁶ | 0.7 | 14 | 30 | 56 |
| 11 | PrBaCo₂O₅ | 24 × 10⁻⁶ | 0.7 | 14 | 57 | 29 |
| 12 | La_{0.6}Sr_{0.4}CoO₃ | 17 × 10⁻⁶ | 0.7 | 14 | 57 | 29 |
| 13 | La_{0.6}Sr_{0.4}CoO₃ | 17 × 10⁻⁶ | 0.7 | 14 | 57 | 29 |
| 14 | La_{0.6}Sr_{0.4}CoO₃ | 17 × 10⁻⁶ | 0.7 | 14 | 57 | 29 |
| 15 | La_{0.6}Sr_{0.4}CoO₃ | 17 × 10⁻⁶ | 0.7 | 14 | 57 | 29 |
| 1C | La_{0.6}Sr_{0.4}CoO₃ | 17 × 10⁻⁶ | 0.5 | 33 | 48 | 19 |
| 2C | Ba_{0.6}La_{0.4}CoO₃ | 30 × 10⁻⁶ | 0.7 | 38 | 41 | 21 |
| 3C | La_{0.6}Sr_{0.4}Co_{0.2}Fe_{0.8}O₃ | 15 × 10⁻⁶ | 0.4 | 33 | 48 | 19 |

| | Air electrode layer | | | Evaluation Results | | |
|---|---|---|---|---|---|---|
| | | Relationship | | | Ratio of | |
| | | between raw | | | voltage | |
| | Content | material | Relationship | Mechanical | variation | Initial |
| Sample | ratio of | particle | of Lₚₒᵣₑ < | deterioration | in cell | resistance |
| No. | Co₃O₄ (%) | diameters | L_{cat} < Lₑₗₑ | (cracking) | (%/kh) | of cell (Ω) |
| 1 | 12 | Ele < Cat | unsatisfied | absence | 1.1 | 1.5 |
| | | | | (None) | | |
| 2 | 12 | Ele < Cat | unsatisfied | absence | 2 | 3.1 |
| 3 | 12 | Ele < Cat | unsatisfied | absence | 1 | 1.6 |
| 4 | 12 | Ele < Cat | unsatisfied | absence | 1 | 1.48 |
| 5 | 12 | Ele < Cat | unsatisfied | absence | 0.03 | 0.9 |
| 6 | 12 | Ele < Cat | unsatisfied | absence | 0.04 | 1.25 |
| 7 | 12 | Ele < Cat | unsatisfied | absence | 0.03 | 0.9 |
| 8 | 12 | Ele < Cat | unsatisfied | absence | 0.04 | 1.52 |
| 9 | 12 | Ele < Cat | unsatisfied | absence | 0.06 | 1.8 |
| 10 | 12 | Ele < Cat | unsatisfied | absence | 0.05 | 1.81 |
| 11 | 12 | Ele < Cat | unsatisfied | absence | 0.06 | 2.1 |
| 12 | 10 | Ele < Cat | unsatisfied | absence | 0.03 | 0.91 |
| 13 | 6 | Ele < Cat | unsatisfied | absence | 0.02 | 0.6 |
| 14 | 2 | Ele < Cat | unsatisfied | absence | 0.03 | 0.55 |
| 15 | 2 | Ele < Cat | satisfied | absence | 0.008 | 0.54 |
| 1C | 2 | Cat < Ele | | presence | 7 | 5.2 |
| | | | | (Yes) | | |
| 2C | 12 | Ele < Cat | | presence | 10 | 11 |
| 3C | 2 | Cat < Ele | | absence | 1 | 2 |

As shown in Table 1 and FIG. 14, the following evaluation results were obtained. In Sample 1C, the value of S_{cat-ele}/S_{cat} of the air electrode layer (0.5) is below the lower limit value (0.5<0.6). Therefore, Sample 1C suffered cracking due to thermal expansion of the air electrode catalyst particles which are composed of the air electrode catalyst material having a high coefficient of linear thermal expansion. Sample 1C could not suppress mechanical degradation of the air electrode layer, and voltage variations (voltage drop) in the cell were also significant.

Although the value of S_{cat-ele}/S_{(cat)} of the air electrode layer (0.7) in Sample 2C meets the requirements of the numerical range specified in the present disclosure (0.7>0.6), the coefficient (30×10⁻⁶) of linear thermal expansion of the air electrode catalyst material composing the air electrode catalyst particles is high. Therefore, Sample 2C suffered cracking due to thermal expansion of the air electrode catalyst material. Sample 2C could not suppress mechanical degradation of the air electrode layer, and voltage variations (voltage drop) in the cell were also significant.

Sample 3C has a low coefficient (15×10⁻⁶) of linear thermal expansion for the air electrode catalyst material composing the air electrode catalyst particles. Therefore, even though the value of S_{cat-ele}/S_{cat} (0.5) in Sample 3C does not meet the requirements of the numerical range specified in the present disclosure, this sample did not suffer cracking due to thermal expansion of the air electrode catalyst material. Sample 3C can suppress mechanical degradation of the air electrode layer. Therefore, Sample 3C does not need to be subjected to the measures in the present disclosure.

In contrast, Samples 1 to 15 use an air electrode catalyst material having a high coefficient of linear thermal expansion (coefficient in a range of 17×10⁻⁶ or more and 24×10⁻⁶ or less) as the air electrode catalyst material composing the air electrode side catalyst particles. However, the values of S_{cat-ele}/S_{cat} (value in a range of 0.7 or more and 0.8 or less) for Samples 1 to 15 meet the requirements of the numerical range specified in the present disclosure. Therefore, in Samples 1 to 15, even if the air electrode catalyst particles attempt to expand thermally, the surface of the air electrode catalyst particles is sufficiently covered (wrapped) by the air electrode electrolyte particles, and the air electrode electrolyte particles can act as the framework to suppress the thermal expansion. As a result, it was confirmed that, according to Samples 1 to 15, it could suppress mechanical deterioration (cracking) of the air electrode layer and suppress voltage variations (voltage drop) in the cell.

When comparing Samples 1 to 15 with each other, it was confirmed that, according to Samples 4 to 15, in which the porosity of the air electrode layer is 25% or less, it could suppress mechanical degradation of the air electrode layer and suppress voltage variations (voltage drop) in the cell, in addition, the initial resistance of the cell could be reduced.

When comparing Samples 1 to 15 with each other, it was confirmed that, according to Samples 5 to 8 and Samples 11 to 15, in which the content ratio of the air electrode electrolyte particles in the air electrode layer is 50% or more, it could improve the framework strength of the air electrode layer due to the air electrode electrolyte particles. This makes it easier to suppress mechanical degradation.

When comparing Samples 1 to 15 with each other, it was confirmed that, according to Samples 1 to 8 and Samples 11 to 15, in which the content ratio of the air electrode catalyst particles in the air electrode layer is 35% or less, it is easier to ensure the content of the air electrode electrolyte particles in the air electrode layer. This makes it easier to reduce the initial resistance of the cell.

When comparing Samples 1 to 15 with each other, it was confirmed that, according to Samples 12 to 15, in which the content ratio of Co₃O₄ in the air electrode layer is 10% or less, it could suppress the decomposition of the perovskite-type oxides containing La, Sr, and Co, which can exhibit a high catalytic capacity. This makes it easier to suppress the increase the resistance of the cell.

According to Samples 1 to 15, it was confirmed that the mechanical strength of the air electrode layer could be improved more in the case of Sample 15, in which the section lengths L_{cat}, Lₑₗₑ, and Lₚₒᵣₑ in the air electrode layer satisfy Lₚₒᵣₑ<L_{cat}<Lₑₗₑ. A reason for the improvement is due to the size of each pore, which is the starting point for crack propagation, being smaller than the size of the framework formed by the air electrode electrolyte particles (the size of the framework of the air electrode layer), in other words, a large size of the framework formed by the air electrode electrolyte particles being larger than the size of each pore, which is the starting point for crack propagation.

The technology of the present disclosure is not limited to the above embodiments and experimental examples. The technology of the present disclosure can be modified in various ways without straying from a purpose of an invention. Any structures presented in the above embodiments and experimental examples can be combined arbitrarily.

The structure produced by the technology in the present disclosure are shown below.

### [Structure 1]

An electrochemical cell including a fuel electrode layer, to which fuel is supplied, a solid electrolyte layer having oxygen ion conductivity, and an air electrode layer, which is a counter electrode to the fuel electrode layer, in which:
the fuel electrode layer, solid electrolyte layer, and air electrode layer are disposed in this order;
the air electrode layer is configured to include a plurality of catalyst particles for an air electrode which is composed of a catalyst material having electron conductivity and oxygen ion conductivity, a plurality of electrolyte particles for the air electrode which is composed of a solid electrolyte material having oxygen ion conductivity, and at least one pore;
the catalyst material has a coefficient of linear thermal expansion at 700° C. within a range of greater than 15×10⁻⁶/K and less than 30×10⁻⁶/K; and when a first total surface area of the catalyst particles for the air electrode for the air electrode is S_{cat}, and a second total surface area of an interface portion where a first surface of the catalyst particles for the air electrode is in contact with a second surface of the electrolyte particles for the air electrode is S_{cat-ele}, the air electrode layer is configured to have a value of S_{cat-ele}/S_{cat} of 0.6 or more.

### [Structure 2]

The electrochemical cell according to structure 1, in which the air electrode layer is configured so that a porosity, which is defined as an area ratio of the pore detected from a cross-section in a thickness direction, is within a range of 5% or more and 25% or less.

### [Structure 3]

The electrochemical cell according to structure 1 or 2, in which the air electrode layer is configured so that a content ratio of the electrolyte particles for the air electrode, which is defined as an area ratio of the electrolyte particles for the air electrode detected from a cross-section in a thickness direction, is within a range of 50% or more and 70% or less.

### [Structure 4]

The electrochemical cell according to any one of structures 1 to 3, in which
the catalyst material for the air electrode is composed of a perovskite-type oxide containing La, Sr, and Co; and
the air electrode layer is configured so that a content ratio of the catalyst particles for the air electrode, which is defined as an area ratio of the catalyst particles for the air electrode detected from a cross-section in a thickness direction, is within a range of 15% or more and 35% or less.

### [Structure 5]

The electrochemical cell according to any one of structures 1 to 4, in which
the catalyst material for the air electrode is composed of a perovskite-type oxide containing La, Sr, and Co; and
the air electrode layer is configured so that a content ratio of Co₃O₄, which is defined as an area ratio of Co₃O₄ detected from a cross-section in a thickness direction, is 10% or less.

### [Structure 6]

The electrochemical cell according to any one of structures 1 to 5, in which
in a cumulative frequency distribution of each section length of the catalyst particle for the air electrode, the electrolyte particle for the air electrode, and the pore, which are detected in a cross-section in a thickness direction, when a section length of the air electrode catalyst particle at 50% cumulative frequency is L_{cat}, a section length of the air electrode electrolyte particle at 50% cumulative frequency is Lₑₗₑ, and a section length of the pore at 50% cumulative frequency is Lₚₒᵣₑ, the air electrode layer is configured to satisfy Lₚₒᵣₑ<L_{cat}<Lₑₗₑ.

### [Structure 7]

The electrochemical cell according to any one of structures 1 to 6, in which
the electrochemical cell is configured to be used as at least one of a solid oxide fuel cell and a solid oxide electrolysis cell.

### [Structure 8]

The electrochemical cell according to structure 1, in which
the air electrode layer is configured so that the value of S_{cat-ele}/S_{cat} is within a range of 0.6 or more and 0.9 or less.

### [Structure 9]

The electrochemical cell according to structure 1, in which
the air electrode catalyst material is composed of a material having the coefficient of linear thermal expansion at 700° C. within a range of 17×10⁻⁶/K or more and 24x10⁻⁶/K or less.

### [Structure 10]

The electrochemical cell according to structure 2, in which
the air electrode layer is configured so that the porosity is within a range of 10% or more and 20% or less.

### [Structure 11]

The electrochemical cell according to structure 3, in which
the air electrode layer is configured so that the content ratio of the electrolyte particles for the air electrode is within a range of 55% or more and 60% or less.

### [Structure 12]

The electrochemical cell according to structure 4, in which
the air electrode layer is configured so that the content of the catalyst particles for the air electrode is within a range of 20% or more and 30% or less.

### [Structure 13]

The electrochemical cell according to structure 5, in which
the air electrode layer is configured so that the content ratio of Co₃O₄ is 7% or less.

What is claimed is:

1. An electrochemical cell comprising:
a fuel electrode layer, to which fuel is supplied;
a solid electrolyte layer having oxygen ion conductivity; and
an air electrode layer, which is a counter electrode to the fuel electrode layer,
wherein:
the fuel electrode layer, solid electrolyte layer, and air electrode layer are disposed in this order;
the air electrode layer comprises a plurality of catalyst particles for an air electrode which is composed of a catalyst material having electron conductivity and oxygen ion conductivity, a plurality of electrolyte particles for the air electrode which is composed of a solid electrolyte material having oxygen ion conductivity, and at least one pore;
the catalyst material has a coefficient of linear thermal expansion at 700° C. within a range of greater than 15×10⁻⁶/K and less than 30×10⁻⁶/K; and
when a first total surface area of the catalyst particles for the air electrode is S_{cat}, and a second total surface area of an interface portion where a first surface of the catalyst particles for the air electrode is in contact with a second surface of the electrolyte particles for the air electrode is S_{cat-ele}, the air electrode layer is configured to have a value of S_{cat-ele}/S_{cat} of 0.6 or more.

2. The electrochemical cell according to claim 1, wherein,
the air electrode layer is configured so that a porosity, which is defined as an area ratio of the pore detected from a cross-section in a thickness direction, is within a range of 5% or more and 25% or less.

3. The electrochemical cell according to claim 1, wherein,
the air electrode layer is configured so that a content ratio of the electrolyte particles for the air electrode, which is defined as an area ratio of the electrolyte particles for the air electrode detected from a cross-section in a thickness direction, is within a range of 50% or more and 70% or less.

4. The electrochemical cell according to claim 1, wherein,
the catalyst material for the air electrode is composed of a perovskite-type oxide containing La, Sr, and Co; and
the air electrode layer is configured so that a content ratio of the catalyst particles for the air electrode, which is defined as an area ratio of the catalyst particles for the air electrode detected from a cross-section in a thickness direction, is within a range of 15% or more and 35% or less.

5. The electrochemical cell according to claim 1, wherein,
the catalyst material for the air electrode is composed of a perovskite-type oxide containing La, Sr, and Co; and
the air electrode layer is configured so that a content ratio of Co₃O₄, which is defined as an area ratio of Co₃O₄ detected from a cross-section in a thickness direction, is 10% or less.

6. The electrochemical cell according to claim 1, wherein,
in a cumulative frequency distribution of each section length of the catalyst particle for the air electrode, the electrolyte particle for the air electrode, and the pore, which are detected in a cross-section in a thickness direction, when a section length of the air electrode catalyst particle at 50% cumulative frequency is L_{cat}, a section length of the air electrode electrolyte particle at 50% cumulative frequency is Lₑₗₑ, and a section length of the pore at 50% cumulative frequency is Lₚₒᵣₑ, the air electrode layer is configured to satisfy Lₚₒᵣₑ<L_{cat}<Lₑₗₑ.

7. The electrochemical cell according to claim 1, wherein,
the electrochemical cell is configured to be used as at least one of a solid oxide fuel cell and a solid oxide electrolysis cell.

8. The electrochemical cell according to claim 1, wherein,
the air electrode layer is configured so that the value of S_{cat-ele}/S_{cat} is within a range of 0.6 or more and 0.9 or less.

9. The electrochemical cell according to claim 5, wherein,
the air electrode layer is configured so that the content ratio of Co₃O₄ is 7% or less.
